(19) United States
(12) Patent Application Publication
(10) Pub. No.: US 2024/0240369 A1
(43) Pub. Date: Jul. 18, 2024

(54) TIRE

(71) Applicant: SUMITOMO RUBBER INDUSTRIES, LTD., Kobe-shi (JP)

(72) Inventor: Mizuki TASHIRO, Kobe-shi (JP)

(73) Assignee: SUMITOMO RUBBER INDUSTRIES, LTD., Kobe-shi (JP)

(21) Appl. No.: 18/404,544

(22) Filed: Jan. 4, 2024

(30) Foreign Application Priority Data
Jan. 18, 2023 (JP) 2023-005981

(51) Int. Cl. D02G 3/48; B60C 9/00; D07B 1/06

(52) U.S. Cl. CPC D02G 3/48; B60C 9/005; D07B 1/0606; D10B 2331/02; D10B 2505/022

(57) ABSTRACT

Provided is a tire with excellent durability. The tire includes a tread rubber and a carcass containing a hybrid cord of at least one polyamide fiber yarn and at least one polyester fiber yarn, the hybrid cord having a twist coefficient K3 of 1800 or more and 2600 or less in final twisting as determined by R3×(D3)^{1/2} where R3 is a final twist number [times/10 cm] of the hybrid cord and D3 is a total fineness [dtex] of the hybrid cord, the twist coefficient K3 and a thickness L [mm] of the tread rubber giving a product (K3×L) of 15000 or more.

This application claims priority to Japanese Patent Application No. 2023-005981 filed on Jan. 18, 2023. The disclosure of Japanese Patent Application No. 2023-005981 is hereby incorporated by reference in its entirety.

### TECHNICAL FIELD

The present disclosure relates to a tire.

### BACKGROUND ART

Many studies have been conducted to improve braking performance and drivability on various road conditions for the purpose of improving vehicle safety. For example, Patent Literature 1 describes that a tire may obtain improved wet grip performance and improved handling performance when the tread portion of the tire includes a rubber composition that contains, relative to the rubber component content, 40 to 125 parts by mass of a filler and 5 to 50 parts by mass of a hydrogenated resin having a softening point of higher than 110° C. and a weight average molecular weight in terms of polystyrene of 200 to 1200 g/mol.

### CITATION LIST

### Patent Literature

Patent Literature 1: WO 2021/125242

### SUMMARY OF DISCLOSURE

### Technical Problem

With the increased demand for electric vehicles in recent years, passenger vehicles and motorcycles are expected to be heavier than before. Tires with higher durability will be requested in the future.

The present disclosure aims to solve the above-described problem and provide tires with excellent durability.

### Solution to Problem

The present disclosure relates to a tire that includes a tread rubber and a carcass containing a hybrid cord of at least one polyamide fiber yarn and at least one polyester fiber yarn, the hybrid cord having a twist coefficient K3 of 1800 or more and 2600 or less in final twisting as determined by R3×(D3)^{1/2} where R3 is a final twist number [times/10 cm] of the hybrid cord and D3 is a total fineness [dtex] of the hybrid cord, the twist coefficient K3 and a thickness L [mm] of the tread rubber giving a product (K3×L) of 15000 or more.

### Advantageous Effects of Disclosure

The tire of the present disclosure includes a tread rubber and a carcass containing a hybrid cord of at least one polyamide fiber yarn and at least one polyester fiber yarn, wherein the K3 is 1800 or more and 2600 or less and the product of K3×L is 15000 or more. Thus, the present disclosure can provide tires with excellent durability.

### BRIEF DESCRIPTION OF DRAWINGS

FIG. 1 shows a cross-sectional view of a motorcycle tire according to the present embodiment.

FIG. 2 shows a developed view of a folded portion of a carcass ply and a band layer.

FIG. 3 shows a cross-sectional view of a motorcycle tire according to another embodiment.

FIG. 4 shows a developed view of a folded portion of a carcass ply and a band layer in FIG. 3.

FIG. 5 shows a cross-sectional view of a motorcycle tire according to another embodiment.

FIG. 6 shows a cross-sectional view of a motorcycle tire according to another embodiment.

### DESCRIPTION OF DISCLOSURE

The tire of the present disclosure includes a tread rubber and a carcass containing a hybrid cord of at least one polyamide fiber yarn and at least one polyester fiber yarn.

The hybrid cord has a twist coefficient K3 of 1800 or more and 2600 or less in final twisting as determined by R3×(D3)^{1/2} where R3 is a final twist number [times/10 cm] of the hybrid cord and D3 is a total fineness [dtex] of the hybrid cord.

The twist coefficient K3 and a thickness L [mm] of the tread rubber give a product (K3×L) of 15000 or more.

Although the reason for the above-described effect is not exactly clear, the effect is believed to be due to the following mechanism.

The present disclosure uses a hybrid cord of a polyamide fiber yarn and a polyester fiber yarn twisted together. The use of the polyester fiber yarn with good fatigue resistance and the polyamide fiber yarn with a high elastic modulus allows a carcass ply to reliably have a higher elasticity and better fatigue resistance than conventional carcass plies. As a result, the durability of the tire is improved.

Moreover, the twist coefficient K3 of the hybrid cord in final twisting is maintained at the predetermined value or more, so that the cord can easily stretch and contract inside the tire to provide good fatigue resistance. As a result, the durability of the tire is improved.

Meanwhile, the longer the distance from the ground contact face of the tire to the cord is, the more the compression set of the cord may be reduced. Therefore, a product (K3×L) of the twist coefficient K3 and the thickness L of the tread rubber is controlled to be 15000 or more, whereby the fatigue resistance of carcass cords can be enhanced and, at the same time, the compression set can be reduced. As a result, the durability of the tire is improved.

In the tire of the present disclosure, the carcass cords and the carcass ply obtain improved durability and, at the same time, the compression set of the cord is reduced. Presumably, the durability is thus improved.

The present disclosure solves the problem (aim) in improving durability by providing a tire that includes a tread rubber and a carcass containing a hybrid cord of at least one polyamide fiber yarn and at least one polyester fiber yarn and satisfies “a product (K3×L) of the twist coefficient K3 and the thickness L of the tread rubber is 15000 or more”. In other words, the parameter of “a product (K3×L) of the twist coefficient K3 and the thickness L of the tread rubber is 15000 or more” does not define the problem (aim). The problem herein is to improve durability. In order to solve the problem, the tire is formulated to satisfy the parameter.

Embodiments of the present disclosure are described below with reference to the drawings. However, the embodiments are merely exemplary embodiments, and the tire of the present disclosure is not limited to the following embodiments.

Herein, the term “normal state” refers to a state where the tire is mounted on a normal rim (not shown), inflated to a normal internal pressure, and under no load.

Herein, the dimensions of the parts of the tire are measured for the tire in the normal state, unless otherwise stated.

If measurement of the tire mounted on a normal rim is impossible, the dimensions and angles of the parts of the tire in a meridional cross-section of the tire are measured in a cross-section of the tire cut along a plane including the axis of rotation, in which the distance between the right and left beads corresponds to the distance between the beads in the tire mounted on a normal rim.

The term “normal rim” refers to a rim specified for each tire by the standard in a standard system including standards according to which tires are provided, and may be, for example, “standard rim” with the applicable size listed in “JATMA YEAR BOOK” of the Japan Automobile Tyre Manufacturers Association, Inc. (JATMA), “measuring rim” listed in “Standards Manual” of the European Tyre and Rim Technical Organisation (ETRTO), or “design rim” listed in “YEAR BOOK” of the Tire and Rim Association, Inc. (TRA). Here, JATMA, ETRTO, and TRA will be referenced in that order, and if the referenced standard includes the applicable size, it will be followed. Moreover, for a tire which is not defined by any of the standards, it refers to a rim with the smallest diameter and, secondly, the narrowest width among the rims on which the tire can be mounted and can maintain the internal pressure, i.e., the rims that cause no air leakage between the rim and the tire.

The term “normal internal pressure” refers to an air pressure specified for each tire by the standard in a standard system including standards according to which tires are provided, and may be “maximum air pressure” in JATMA, “inflation pressure” in ETRTO, or the maximum value shown in Table “TIRE LOAD LIMITS AT VARIOUS COLD INFLATION PRESSURES” in TRA. Like “normal rim”, JATMA, ETRTO, and TRA will be referenced in that order, and the corresponding standard will be followed. Moreover, for a tire which is not defined by any of the standards, it refers to a normal internal pressure of 250 kPa or more for another tire size defined by any of the standards, for which the normal rim is listed as the standard rim. Here, when a plurality of normal internal pressures of 250 kPa or more are listed, it refers to the smallest one of these normal internal pressures.

Also herein, the term “normal load” refers to a load specified for each tire by the standard in a standard system including standards according to which tires are provided, and may be “maximum load capacity” in JATMA, “load capacity” in ETRTO, or the maximum value shown in Table “TIRE LOAD LIMITS AT VARIOUS COLD INFLATION PRESSURES” in TRA. Like “normal rim” and “normal internal pressure” described above, JATMA, ETRTO, and TRA will be referenced in that order, and the corresponding standard will be followed. Moreover, for a tire which is not defined by any of the standards, the normal load W_{L} is calculated by the following equations.

V={(Dt/2)²−(Dt/2−Ht)²}×n×Wt

W_{L}=0000011×V+175
W_{L}: normal load (kg)
V: virtual volume (mm³) of tire
Dt: outer diameter (mm) of tire
Ht: cross-sectional height (mm) of tire
Wt: cross-sectional width (mm) of tire

The term “cross-sectional width Wt (mm)” of the tire refers to the width of the tire in the normal state corresponding to the largest distance between the outer surfaces of the sidewalls, excluding patterns, letters, and the like on the sides of the tire, if present.

The term “outer diameter Dt (mm)” of the tire refers to the outer diameter of the tire in the normal state.

The term “cross-sectional height Ht (mm)” of the tire refers to the height in the tire radial direction in a radial cross-section of the tire. Provided that the rim diameter of the tire is R (mm), the height corresponds to half of the difference between the outer diameter Dt of the tire and the rim diameter R. In other words, the cross-sectional height Ht can be determined by (Dt−R)/2.

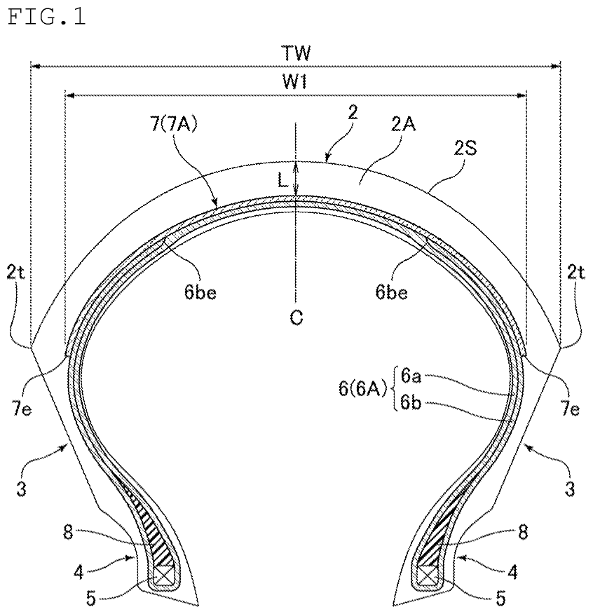

As shown in FIG. 1, a motorcycle tire (hereinafter, also referred to simply as “tire”) 1 of the present embodiment includes a carcass 6 extending from a tread portion 2 via a sidewall portion 3 to a bead core 5 of a bead portion 4, and a band layer (belt layer) 7 disposed outwardly of the carcass 6 and inwardly of the tread portion 2 in the tire radial direction.

In the tire 1, in order to have a sufficient ground contact area even during turning with a large camber angle, an outer face 2S between a tread edge 2t and the other tread edge 2t of the tread portion 2 extends while curving in an arc shape protruding outwardly in the tire radial direction, and a tread width TW between the tread edges 2t and 2t in the tire axial direction is the largest width of the tire.

The carcass 6 consists of at least one folded carcass ply 6A that includes a main body 6a extending from the tread portion 2 via the sidewall portion 3 to the bead core 5 of the bead portion 4 and a folded portion 6b extending from the main body 6a and folded around the bead core 5 from the inside to the outside in the tire axial direction. In the present embodiment, the carcass 6 consists of one folded carcass ply 6A. A bead apex 8 formed of a hard rubber is disposed between the main body 6a and the folded portion 6b of the folded carcass ply 6A.

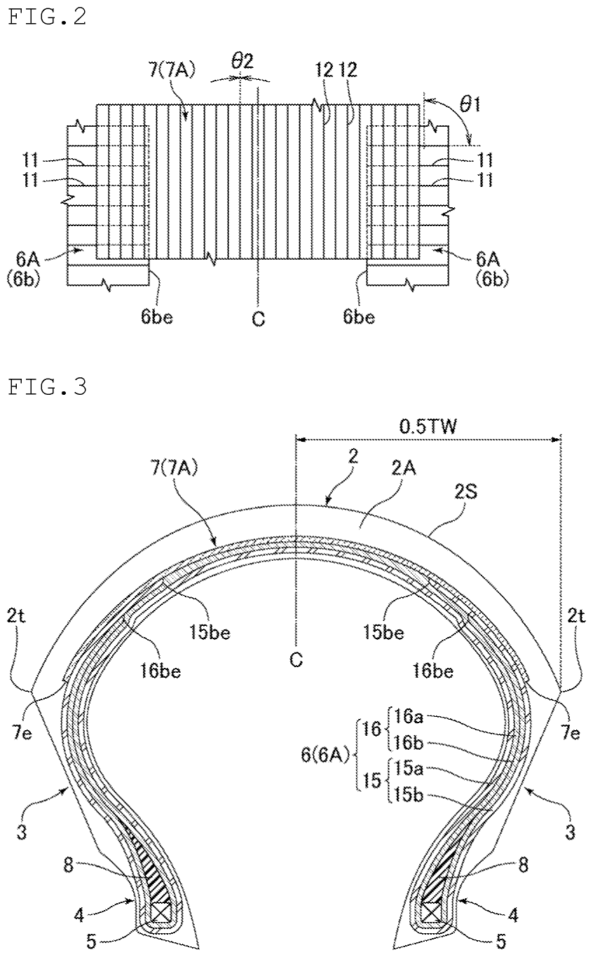

The folded carcass ply 6A contains carcass cords 11 which are inclined at an angle θ1 of, for example, 65 to 90 degrees relative to the tire circumferential direction as shown in FIG. 2.

In the tire 1, the carcass cords 11 are each a hybrid cord of at least one polyamide fiber yarn and at least one polyester fiber yarn. The polyamide fiber and the polyester fiber forming the polyamide fiber yarn and the polyester fiber yarn, respectively, may be synthetic fibers or biomass-derived fibers. In view of life cycle assessment, the fibers are desirably obtained from recycled or recovered materials.

Here, the term “filament” refers to the minimum unit of a fiber forming a cord. The term “yarn” refers to combined filaments. A yarn may consist of multiple filaments twisted together.

Non-limiting examples of the hybrid cord include a hybrid cord formed by combining two 1100 dtex multifilament yarns each having undergone 48 times/10 cm first twisting, and subjecting the combined two first-twisted multifilament yarns to final twisting for the same number of times and in the opposite or same direction to the first twisting (i.e., 1100/2 dtex) and a hybrid cord formed by combining two 1670 dtex multifilament yarns each having undergone 40 times/10 cm first twisting, and subjecting the combined two first-twisted multifilament yarns to final twisting for the same number of times and in the opposite or same direction to the first twisting (i.e., 1670/2 dtex).

In order to better achieve the advantageous effect, the hybrid cord used is desirably a hybrid cord of twisted two yarns consisting of one polyamide fiber yarn and one polyester fiber yarn or a hybrid cord of twisted three yarns consisting of one polyamide fiber yarn and two polyester fiber yarns.

Although the reason for the above-described effect particularly derived from such a hybrid cord is not exactly clear, the effect is believed to be due to the following mechanism.

The yarn of twisted polyamide filaments is highly elastic and resistant to deformation but has poor fatigue resistance. In contrast, the yarn of twisted polyester filaments has high fatigue resistance but has a low elastic modulus and a low strength. A combination of these two types of yarns twisted together can form a cord with improved strength and improved fatigue resistance. Thus, comprehensively, the cord as a whole can obtain improved durability.

Examples of the polyamide forming the polyamide fiber include aliphatic polyamides, semi-aromatic polyamides, and fully aromatic polyamides. In order to better achieve the advantageous effect, semi-aromatic polyamides and fully aromatic polyamides are desirable among these.

Aliphatic polyamides refer to polyamides having a backbone in which straight carbon chains are connected via amide bonds. Examples include Nylon 4 (PA4), Nylon 410 (PA410), Nylon 6 (PA6), Nylon 66 (PA66), Nylon 610 (PA610), Nylon 10 (PA10), Nylon 1010 (PA1010), Nylon 1012 (PA1012), and Nylon 11 (PA11). Among these are Nylon 4, Nylon 410, Nylon 610, Nylon 10, Nylon 1010, Nylon 11, etc. which can be easily formed partially or fully from biomass-derived materials.

Examples of Nylon 6 and Nylon 66 include those which are produced by ring-opening polymerization of conventional chemically synthesized caprolactam and those which are produced by condensation polymerization of hexamethylenediamine and adipic acid. Examples also include Nylon 6 and Nylon 66 produced from bio-caprolactam, or bio-adipic acid and bio-hexamethylenediamine, made from bio-derived cyclohexane as a starting material. Moreover, the above-described biological raw materials may be formed from sugars such as glucose. Such Nylon 6 and Nylon 66 are considered to have a similar strength to conventional ones.

Non-limiting typical examples of Nylon 4 include those made from 2-pyrrolidone produced by converting bio-fermented glutamic acid to γ-aminobutyric acid. Since Nylon 4 features good thermal/mechanical stability and easy polymer structure design, it contributes to improvements in tire performance and strength and therefore can be suitably used.

Nylon 410, Nylon 610, Nylon 1010, Nylon 1012, Nylon 11, etc. may be made from ricinoleic acid obtained from castor oil (Ricinus communis), etc. Specifically, Nylon 410, Nylon 610, and Nylon 1010 can be produced by condensation polymerization of sebacic acid or dodecanedioic acid obtained from castor oil with any diamine compound. Nylon 11 can be produced by condensation polymerization of 11-aminoundecanoic acid obtained from castor oil.

Semi-aromatic polyamides refer to polyamides having an aromatic ring on a part of the molecular chain. Examples include Nylon 4T (PA4T), Nylon 6T (PA6T), and Nylon 10T (PA10T).

Nylon 4T, Nylon 6T, and Nylon 10T can be produced by condensation polymerization of terephthalic acid as a dicarboxylic acid with any diamine compound having the corresponding number of carbons. Here, these nylon materials may be produced from the biomass-derived terephthalic acid described above. They have a rigid cyclic structure in the molecular chain and therefore are excellent in properties such as heat resistance.

Other examples of the above-described aliphatic polyamides and semi-aromatic polyamides include polyamide 5X produced by polymerizing 1,5-pentanediamine derived from lysine with a dicarboxylic acid (where X represents the number of carbons derived from the dicarboxylic acid and is an integer or T indicating terephthalic acid).

Examples of the fully aromatic polyamides include polyamides having a backbone in which aromatic rings are connected via amide bonds, such as polyparaphenylene telephthalamide. Like the above-described aliphatic polyamides and semi-aromatic polyamides, the fully aromatic polyamides may be produced by binding biomass-derived terephthalic acid to phenylenediamine.

Examples of the polyester forming the polyester fiber include polyethylene terephthalate (PET), polyethylene naphthalate (PEN), and polyethylene furanoate (PEF). In order to better achieve the advantageous effect, PET is desirable among these.

When the polyester is a biomass-derived polyester, suitable examples thereof include biomass PET prepared using biomass-derived terephthalic acid or ethylene glycol and biomass PEF prepared using biomass-derived furandicarboxylic acid.

The biomass polyester can be formed from biomass terephthalic acid, biomass ethylene glycol, etc. which are produced by converting bioethanol or furfurals, carenes, cymenes, terpenes, etc., or by converting various animal- or plant-derived compounds, or by directly fermenting microorganisms, etc.

The hybrid cord may also be obtained by recovery and refinement from used products such as drink bottles or clothing, followed by re-spinning, regardless of whether it is a synthetic or biomass-derived cord.

The hybrid cord is preferably previously coated with an adhesive layer to ensure good adhesion to the coating layer. The adhesive layer may be a known one. Examples include those formed by treatment with a resorcinol-formaldehyde-rubber latex (RFL), as well as those formed by epoxy treatment with an adhesive composition containing a sorbitol polyglycidyl ether and a blocked isocyanate and then RFL treatment, and those formed by treatment with an adhesive composition containing a halohydrin compound, a blocked isocyanate compound, and a rubber latex.

Examples of the resorcinol-formaldehyde-rubber latex (RFL) include an adhesive composition containing a natural rubber and/or synthetic rubber latex and a co-condensate of phenol-formaldehyde and resorcinol as described in JP S48-11335 A, which is hereby incorporated by reference in its entirety. Such an adhesive composition can be prepared by, for example, a method including condensing phenol and formaldehyde in the presence of an alkaline catalyst, copolymerizing an aqueous phenol-formaldehyde resin solution with resorcinol, and mixing the resulting phenol-formaldehyde-resorcinol resin solution with a latex rubber.

Here, examples of the synthetic rubber latex include butadiene polymer latex, styrene-butadiene copolymer latex, polyisoprene polymer latex, butadiene-acrylonitrile copolymer latex, butadiene-vinyl pyridine polymer latex, and butadiene-vinylpyridine-styrene copolymer latex.

The adhesive layer formed of the resorcinol-formaldehyde-rubber latex (RFL) may be formed by attaching a RFL adhesive (for example, by dipping the cord in a RFL liquid). The RFL adhesive is usually attached after a fiber cord is obtained by twisting, but it may be attached before or during the twisting.

The composition of the RFL adhesive is not limited and may be appropriately selected. In particular, it is preferably a composition that contains 0.1 to 10% by mass of resorcinol, 0.1 to 10% by mass of formaldehyde, and 1 to 28% by mass of latex, more preferably a composition that contains 0.5 to 3% by mass of resorcinol, 0.5 to 3% by mass of formaldehyde, and 10 to 25% by mass of latex.

For example, heating may be performed by drying a cord with a RFL adhesive composition attached thereto at 100° C. to 250° C. for one to five minutes and then heat-treating the resulting cord at 150° C. to 250° C. for one to five minutes. The heat treatment conditions after the drying are desirably at 180° C. to 240° C. for one to two minutes.

The adhesive composition containing a sorbitol polyglycidyl ether and a blocked isocyanate may be any composition that contains a sorbitol polyglycidyl ether and a blocked isocyanate. In particular, the adhesive composition desirably contains an epoxy compound that is a sorbitol polyglycidyl ether and has a chlorine content of 9.6% by mass or lower, and a blocked isocyanate.

Examples of the sorbitol polyglycidyl ether include sorbitol diglycidyl ether, sorbitol triglycidyl ether, sorbitol tetraglycidyl ether, sorbitol pentaglycidyl ether, sorbitol hexaglycidyl ether, and mixtures thereof. The adhesive composition may contain a sorbitol monoglycidyl ether. The sorbitol polyglycidyl ether has a large number of epoxy groups in one molecule and can form a highly crosslinked structure.

The chlorine content of the sorbitol polyglycidyl ether is preferably 9.6% by mass or lower, more preferably 9.5% by mass or lower, still more preferably 9.4% by mass or lower, particularly preferably 9.3% by mass or lower. The lower limit of the chlorine content is not limited and may be 1% by mass or higher, for example.

In the present disclosure, the chlorine content of the sorbitol polyglycidyl ether can be determined by the method described in JIS K 7243-3, for example.

The chlorine content of the sorbitol polyglycidyl ether may be reduced, for example, by reducing the amount of epichlorohydrin used in the synthesis of the epoxy compound.

The blocked isocyanate is a compound which is produced by reaction of an isocyanate compound and a blocking agent and is temporarily deactivated by the group derived from the blocking agent. When heated at a predetermined temperature, the group derived from the blocking agent can dissociate to form an isocyanate group.

Examples of the isocyanate compound include those having two or more isocyanate groups in the molecule.

Examples of diisocyanates having two isocyanate groups include hexamethylene diisocyanate, diphenylmethane diisocyanate, xylylene diisocyanate, isophorone diisocyanate, phenylene diisocyanate, tolylene diisocyanate, trimethylhexamethylene diisocyanate, metaphenylene diisocyanate, naphthalene diisocyanate, diphenyl ether diisocyanate, diphenylpropane diisocyanate, and biphenyl diisocyanate, as well as isomers, alkyl-substituted products, halides, and benzene ring-hydrogenated products of these diisocyanates. Also usable are triisocyanates having three isocyanate groups, tetraisocyanates having four isocyanate groups, polymethylene polyphenyl polyisocyanates, etc. These isocyanate compounds may be used alone or in combinations of two or more. Tolylene diisocyanate, metaphenylene diisocyanate, diphenylmethane diisocyanate, hexamethylene diisocyanate, and polymethylene polyphenyl polyisocyanate are preferred among these.

Examples of the blocking agent include lactam blocking agents such as ε-caprolactam, δ-valerolactam, γ-butyrolactam, and β-propiolactam; phenolic blocking agents such as phenol, cresol, resorcinol, and xylenol; alcohol blocking agents such as methanol, ethanol, n-propyl alcohol, isopropyl alcohol, n-butyl alcohol, isobutyl alcohol, tert-butyl alcohol, ethylene glycol monoethyl ether, ethylene glycol monobutyl ether, diethylene glycol monoethyl ether, propylene glycol monomethyl ether, and benzyl alcohol; oxime blocking agents such as formamidoxime, acetaldoxime, acetoxime, methyl ethyl ketoxime, diacetyl monoxime, benzophenone oxime, and cyclohexanone oxime; and active methylene blocking agents such as dimethyl malonate, diethyl malonate, ethyl acetoacetate, methyl acetoacetate, and acetylacetone. Lactam blocking agents, phenolic blocking agents, and oxime blocking agents are preferred among these.

In the adhesive composition containing a sorbitol polyglycidyl ether and a blocked isocyanate, the amount of the blocked isocyanate per 100 parts by mass of the sorbitol polyglycidyl ether is preferably 50 parts by mass or more, more preferably 200 parts by mass or more. The upper limit is preferably 500 parts by mass or less, more preferably 400 parts by mass or less.

The adhesive composition containing a sorbitol polyglycidyl ether and a blocked isocyanate may optionally contain any of the following optional components: epoxy compounds other than the sorbitol polyglycidyl ether, resins coporimerizable with the sorbitol polyglycidyl ether, curing agents other than the blocked isocyanate, organic thickeners, antioxidants, photostabilizers, adhesion improvers, reinforcing agents, softeners, colorants, leveling agents, flame retardants, antistatic agents, etc.

Examples of the epoxy compounds other than the sorbitol polyglycidyl ether include glycidyl ethers such as ethylene glycol glycidyl ether, glycerol polyglycidyl ether, diglycerol polyglycidyl ether, polyglycerol polyglycidyl ether, bisphenol A diglycidyl ether, bisphenol S diglycidyl ether, novolac glycidyl ether, and brominated bisphenol A diglycidyl ether; glycidyl esters such as hexahydrophthalic acid glycidyl ester (monoester or diester) and dimer acid glycidyl ester; glycidyl amines such as triglycidyl isocyanurate, glycidyl hydantoin, tetraglycidyl diaminodiphenylmethane, triglycidyl para-aminophenol, triglycidyl meta-aminophenol, diglycidyl aniline, diglycidyl toluidine, tetraglycidyl meta-xylenediamine, diglycidyl tribromoaniline, and tetraglycidyl bisaminomethylcyclohexane; and alicyclic or aliphatic epoxides such as 3,4-epoxycyclohexylmethyl carboxylate, epoxidized polybutadiene, and epoxidized soybean oil.

Examples of the treatment with the adhesive composition containing a sorbitol polyglycidyl ether and a blocked isocyanate include treatment performed to attach the components in RFL to the cord, optionally followed by heating.

For example, the attachment may be carried out by any method such as application with a roller, spraying through a nozzle, or immersion in a bath liquid (adhesive composition). In view of uniform attachment and removal of the excessive adhesive, attachment by immersion is preferred.

Moreover, other means may be further used to control the amount attached to the cord, such as squeezing with a pressure roller, scraping off with a scraper or the like, blowing off with air, suction, and beating with a beater.

The amount attached to the cord is preferably 1.0% by mass or more, more preferably 1.5% by mass or more, while it is preferably 3.0% by mass or less, more preferably 2.5% by mass or less.

Here, the amount attached to the cord refers to the amount of the solids in the RFL adhesive attached per 100 parts by mass of the cord.

The total solid concentration of the adhesive composition containing a sorbitol polyglycidyl ether and a blocked isocyanate is preferably 0.9% by mass or higher, more preferably 14% by mass or higher, while it is preferably 29% by mass or lower, more preferably 23% by mass or lower.

In addition to resorcinol, formaldehyde, and a rubber latex, additives such as a vulcanization regulator, zinc oxide, an antioxidant, and a defoamer may be added to the adhesive composition containing a sorbitol polyglycidyl ether and a blocked isocyanate.

For example, heating may be performed by drying a reinforcing material with a RFL adhesive composition attached thereto at 100° C. to 250° C. for one to five minutes and then heat-treating the resulting material at 150° C. to 250° C. for one to five minutes. The heat treatment conditions after the drying are desirably at 180° C. to 240° C. for one to two minutes.

The adhesive composition containing a halohydrin compound, a blocked isocyanate compound, and a rubber latex may be any composition containing these components. It is desirably an adhesive composition that contains a halohydrin compound, a blocked isocyanate compound, and a rubber latex and does not contain resorcinol and formaldehyde.

Examples of the halohydrin compound include compounds produced by reacting a polyol compound and an epihalohydrin compound (halohydrin ether).

The polyol compound refers to a compound having two or more hydroxyl groups in the molecule. Examples include glycols such as ethylene glycol, propylene glycol, polyethylene glycol, and polypropylene glycol, hydroxylic acids such as erythritol, xylitol, sorbitol, and tartaric acid, glyceric acid, glycerol, diglycerol, polyglycerol, trimethylolpropane, trimethylolethane, and pentaerythritol.

Examples of the epihalohydrin compound include epichlorohydrin and epibromohydrin.

Examples of the halohydrin compound include fluoroalcohol compounds, chlorohydrin compounds, bromohydrin compounds, and iodohydrin compounds. Halogenated sorbitols and halogenated glycerols are preferred among these.

The halogen content based on 100% by mass of the halohydrin compound is preferably 5.0 to 15.0% by mass, more preferably 7.0 to 13.0% by mass, still more preferably 9.0 to 12.0% by mass.

Examples of the blocked isocyanate compound include compounds described above for the blocked isocyanate. Moreover, examples of the rubber latex include those described above for the rubber latex.

The adhesive composition containing a halohydrin compound, a blocked isocyanate compound, and a rubber latex desirably contains 10.0 to 30.0 parts by mass of the halohydrin compound, 10.0 to 30.0 parts by mass of the blocked isocyanate compound, and 80.0 to 240.0 parts by mass of the rubber latex. The adhesive composition desirably does not contain resorcinol and formaldehyde.

An adhesive layer formed of the adhesive composition containing a halohydrin compound, a blocked isocyanate compound, and a rubber latex is formed on the surface of the cord using the adhesive composition. For example, the adhesive layer may be formed by, but not limited to, immersion, brushing, casting, spraying, roll coating, or knife coating.

The hybrid cord constituting the carcass cords 11 in the carcass ply 6A has a twist coefficient K3 [times·(dtex)^{1/2}/10 cm] of 1800 or more and 2600 or less in final twisting. The twist coefficient K3 is determined by R3×(D3)^{1/2} where R3 is a final twist number [times/10 cm] of the hybrid cord and D3 is a total fineness [dtex] of the hybrid cord.

The twist coefficient K3 is preferably 1876 or more, more preferably 2000 or more, still more preferably 2011 or more, further preferably 2058 or more, further preferably 2111 or more, further preferably 2200 or more, further preferably 2280 or more, further preferably 2298 or more, further preferably 2300 or more, further preferably 2312 or more, further preferably 2368 or more, further preferably 2427 or more, while it is preferably 2550 or less, more preferably 2500 or less, still more preferably 2450 or less. When the twist coefficient K3 is within the range indicated above, the advantageous effect tends to be better achieved.

The term “total fineness” refers to the fineness of the cord as a whole, and the term “fineness” refers to the weight (g/10000 m) of 10000 m of the cord. The total fineness can be determined by measuring the weights of the carcass cords 11 taken from the tire after removing rubber adhered to the surfaces of the cords. Specifically, the weights of five carcass cords 11 taken from the carcass ply 6A are measured and averaged, and the average is used as the total fineness.

If it is not possible to take out the carcass cords 11 with a length of 10000 m, five carcass cords 11 with a length of 10 cm or more are taken out and individually weighed, the weights per 10000 m are calculated from the respective measured weights, and the calculated weights of the five carcass cords 11 are averaged, whereby the total fineness can be determined.

Although the reason for the above-described effect derived from the twist coefficient K3 within the range indicated above, particularly 2200 or more and 2500 or less, is not exactly clear, the effect is believed to be due to the following mechanism.

The twist coefficient is an index determined from the twist number in twisting a plurality of yarns and the fineness. A higher index may mean a larger twist number and a larger fiber diameter. Therefore, the twist coefficient is controlled to be the predetermined value or more to allow the cord as a whole to be more stretchable and less breakable. Thus, improvement of durability may be facilitated.

The final twist number R3 [times/10 cm] of the hybrid cord constituting the carcass cords 11 in the carcass ply 6 A is preferably 30.0 or more, more preferably 35.0 or more, still more preferably 40.0 or more, while it is preferably 57.0 or less, more preferably 55.0 or less, still more preferably 45.0 or less, particularly preferably 42.0 or less. When the final twist number R3 is within the range indicated above, the advantageous effect tends to be better achieved.

Although the reason for the above-described effect derived from the final twist number R3 within the range indicated above, particularly 30.0 to 55.0 times/10 cm, is not exactly clear, the effect is believed to be due to the following mechanism.

An increase in the final twist number R3 allows the carcass cords 11 to stretch flexibly, so that the cord may more flexibly respond to stretching deformation during rolling. Meanwhile, if the final twist number R3 is excessively large, the carcass cords 11 under compression deformation in the tread portion and the like may be more likely to be broken by the compression. Therefore, the final twist number R3 is controlled to be within the range indicated above, thereby obtaining good durability.

The total fineness D3 of the hybrid cord constituting the carcass cords 11 in the carcass ply 6A is preferably 1400 dtex or more, more preferably 1600 dtex or more, still more preferably 2200 dtex or more, further preferably 2770 dtex or more, particularly preferably 3300 dtex or more, while it is preferably 5500 dtex or less, more preferably 4000 dtex or less, still more preferably 3500 dtex or less, particularly preferably 3340 dtex or less. When the total fineness D3 is within the range indicated above, the advantageous effect tends to be better achieved.

Although the reason for the above-described effect derived from the total fineness D within the range indicated above, particularly 1600 to 5500 dtex, is not exactly clear, the effect is believed to be due to the following mechanism.

The total fineness is the weight of 10000 m of the cord as described above. The higher the total fineness is, the cord as a whole has a larger diameter and has a higher strength. Meanwhile, if the fineness is excessively high, the cord becomes stiff and may be less resistant to compression deformation. Therefore, the total fineness is controlled to be within the range indicated above, thereby facilitating improvement of durability.

In order to better achieve the advantageous effect, in the carcass cords 11 in the carcass ply 6A, provided that: the polyester fiber yarn has a twist coefficient K2 in first twisting as determined by R2×(D2)^{1/2} where R2 is a first twist number [times/10 cm] of the polyester fiber yarn and D2 is a fineness [dtex] of the polyester fiber yarn; and the polyamide fiber yarn has a twist coefficient K1 in first twisting as determined by R1×(D1)^{1/2} where R1 is a first twist number [times/10 cm] of the polyamide fiber yarn and D1 is a fineness [dtex] of the polyamide fiber yarn, a ratio (K1/K2) of the twist coefficient K1 to the twist coefficient K2 is preferably 0.88 or higher.

The ratio K1/K2 is preferably 0.91 or higher, more preferably 0.92 or higher, still more preferably 1.00 or higher, further preferably 1.10 or higher, further preferably 1.11 or higher, further preferably 1.12 or higher, while it is preferably 1.36 or lower, more preferably 1.30 or lower, still more preferably 1.20 or lower, further preferably 1.19 or lower, further preferably 1.14 or lower. When the ratio is within the range indicated above, the advantageous effect tends to be better achieved.

Although the reason for the above-described effect derived from the ratio K1/K2 within the range indicated above, particularly 1.00 or higher and 1.30 or lower, is not exactly clear, the effect is believed to be because the ratio K1/K2 controlled to be within the range indicated above increases the twist angle of the polyamide fiber which is disadvantageous for fatigue resistance. As a result, the durability is improved.

The term “fineness” refers to the fineness of the yarn as a whole and is the weight (g/10000 m) of 10000 m of the yarn. The fineness can be determined by taking the carcass cords 11 from the tire, removing the rubber adhered to the surfaces thereof, and measuring the individual weight of the yarns in the cords. Like the total fineness of the carcass cords 11, five carcass cords 11 are taken from the carcass ply 6A, the weight of each yarn in the five carcass cords 11 is weighed, the measured weights are averaged, and the average is used as the fineness. If it is not possible to take out the carcass cords 11 with a length of 10000 m, five carcass cords 11 with a length of 10 cm or more are taken out, the weights of yarns in the five carcass cords 11 are measured, the weights per 10000 m of the yarns are calculated from the measured weights, the calculated values are averaged, and the average can be used as the fineness of the yarn.

The twist coefficient K1 is preferably 1200 or more, more preferably 1273 or more, still more preferably 1300 or more, further preferably 1323 or more, further preferably 1327 or more, further preferably 1344 or more, further preferably 1500 or more, further preferably 1556 or more, further preferably 1559 or more, particularly preferably 1600 or more, while it is preferably 2300 or less, more preferably 2100 or less, still more preferably 2000 or less, further preferably 1921 or less, further preferably 1839 or less. When the twist coefficient K1 is within the range indicated above, the advantageous effect tends to be better achieved.

The twist coefficient K2 is preferably 1100 or more, more preferably 1131 or more, still more preferably 1161 or more, further preferably 1200 or more, further preferably 1273 or more, further preferably 1327 or more, further preferably 1349 or more, further preferably 1400 or more, further preferably 1410 or more, further preferably 1455 or more, further preferably 1600 or more, further preferably 1697 or more, while it is preferably 2000 or less, more preferably 1900 or less, still more preferably 1800 or less, further preferably 1716 or less. When the twist coefficient K2 is within the range indicated above, the advantageous effect tends to be better achieved.

The first twist number R1 [times/10 cm] of the polyamide fiber yarn in the carcass cords 11 in the carcass ply 6A is preferably 35.0 or more, more preferably 40.0 or more, still more preferably 45.0 or more, while it is preferably 60.0 or less, more preferably 55.0 or less, still more preferably 50.0 or less, further preferably 47.5 or less, particularly preferably 47.0 or less. When the first twist number R1 is within the range indicated above, the advantageous effect tends to be better achieved.

The first twist number R2 [times/10 cm] of the polyester fiber yarn in the carcass cords 11 in the carcass ply 6A is preferably 33.0 or more, more preferably 35.0 or more, still more preferably 40.0 or more, further preferably 42.0 or more, while it is preferably 60.0 or less, more preferably 55.0 or less, still more preferably 50.0 or less, further preferably 45.0 or less, further preferably 42.5 or less. When the first twist number R2 is within the range indicated above, the advantageous effect tends to be better achieved.

FIG. 1 indicates that a tread rubber 2A in the tread portion 2 has a thickness L [mm]. A product (K3×L) [times(dtex)^{1/2}/100] of the twist coefficient K3 [times' (dtex)^{1/2}/10 cm] and the thickness L [mm] of the tread portion 2 is 15000 or more.

The product of L×K3 is preferably 15009 or more, more preferably 15079 or more, still more preferably 16182 or more, further preferably 17000 or more, further preferably 17100 or more, further preferably 18000 or more, further preferably 18494 or more, further preferably 18521 or more, further preferably 18996 or more, further preferably 19000 or more, further preferably 20000 or more, further preferably 20632 or more, while it is preferably 25000 or less, more preferably 24000 or less, still more preferably 23000 or less, further preferably 21829 or less, further preferably 21315 or less. When the product is within the range indicated above, the advantageous effect tends to be better achieved.

The thickness L of the tread rubber 2A is preferably 6.0 mm or more, more preferably 7.0 mm or more, still more preferably 7.5 mm or more, further preferably 8.0 mm or more, particularly preferably 8.5 mm or more, while it is preferably 12.0 mm or less, more preferably 9.5 mm or less, still more preferably 9.0 mm or less. When the thickness is within the range indicated above, the advantageous effect tends to be better achieved.

A product (R3×L) [times/100] of the final twist number R3 [times/10 cm] of the hybrid cord and the thickness L [mm] of the tread rubber 2A in the carcass cords 11 in the carcass ply 6A is desirably 280.0 or more and 500.0 or less.

The product of R3×L is preferably 320.0 or more, more preferably 340.0 or more, still more preferably 350.0 or more, particularly preferably 357.0 or more, while it is preferably 495.0 or less, more preferably 450.0 or less, still more preferably 427.5 or less, further preferably 405.0 or less, further preferably 380.0 or less. When the product is within the range indicated above, the advantageous effect tends to be better achieved.

Although the reason for the above-described effect derived from the product of R3×L within the range indicated above, particularly 340.0 or more and 405.0 or less, is not exactly clear, the effect is believed to be due to the following mechanism.

The longer the distance from the ground contact face of the tire to the cord is, the more the compression set of the cord may be reduced. Further, when the twist number R3 is increased, the strength increases, but the resistance to compression tends to be reduced. Therefore, a product (R3×L) of the twist number R3 and the thickness L of the tread rubber is controlled to be within the predetermined range to not only enhance the fatigue resistance of the carcass cords but also reduce compression set. As a result, the durability of the tire is improved.

A product ((K1/K2)×L) [times/100] of the ratio K1/K2 and the thickness L [mm] of the tread rubber 2A in the carcass cords 11 in the carcass ply 6A is desirably 6.9 or more and 10.0 or less.

The product of (K1/K2)×L is preferably 8.0 or more, more preferably 8.2 or more, still more preferably 8.3 or more, further preferably 8.6 or more, particularly preferably 9.0 or more, while it is preferably 9.8 or less, more preferably 9.7 or less, still more preferably 9.5 or less. When the product is within the range indicated above, the advantageous effect tends to be better achieved.

Although the reason for the above-described effect derived from the product of (K1/K2)×L within the range indicated above, particularly 8.6 or more and 9.7 or less, is not exactly clear, the effect is believed to be due to the following mechanism.

The higher the ratio K1/K2 is, the more the polyamide fiber yarn becomes relatively stretchable, so that a high strength can be obtained. Further, the longer the distance from the ground contact face of the tire to the cord is, the more the compression set of the cord may be reduced. Therefore, a product (K1/K2×L) is controlled to be within the predetermined range to not only enhance the fatigue resistance but also reduce compression set. As a result, the durability of the tire is improved.

In the present disclosure, the “thickness of the tread rubber” refers to the thickness of the tread rubber measured on the tire equator in a radial cross-section of the tire. The thickness L of the tread rubber is measured along the normal of the tread rubber surface at the tire equator and corresponds to the distance from the tread rubber surface to the interface, which is closest to the tire surface, of the band layer, carcass layer, belt-reinforcing layer, or other reinforcing layer containing steel or textile or other fiber material. When the tread rubber has a groove on the tire equator, the thickness of the tread rubber is the linear distance from a plane defined by a straight line connecting the outermost edges of the groove in the tire radial direction. In the tire 1 in FIG. 1, the thickness L of the tread rubber is a linear distance from the surface of the tread rubber on the tire equator C to the outer surface of the band layer (belt layer) 7 in the tire radial direction.

The tread rubber 2A may be a two-layer tread rubber or a three or more-layer tread rubber, as well as the monolayer tread rubber in FIG. 1. The thickness of a multi-layer tread rubber refers to the distance from the tread rubber surface, specifically, the surface of the outermost rubber layer of the multi-layer tread rubber, to an interface, which is on the outermost surface side of the tire, of the reinforcing layer, as described for the monolayer tread rubber.

The band layer (belt layer) 7 consists of one jointless ply 7 including one or a plurality of rubber-coated band cords 12 spirally wound at an angle 82 of not more than 5 degrees relative to the tire circumferential direction.

This jointless ply 7A can exhibit a restriction force for the tire in the circumferential direction and can reduce the deformation of the tread portion during driving. Thus, improvement of durability may be facilitated.

In order to improve the durability described above, a width W1 (shown in FIG. 1) of the jointless ply 7A in the tire axial direction is desirably about 85 to 95% of the tread width TW. For the same purpose, belt cords 12 are preferably aramid fiber cords or steel cords each having a high tensile strength.

The length of an arc defined by the band layer (belt layer) 7 in a radial cross-section of the tire is preferably longer than the tread width TW. When the length of the arc defined by the band layer (belt layer) 7 is longer than the tread width TW, the surface of the tread portion can be more easily maintained in a round shape, thereby facilitating improvement of handling stability.

When a steel cord is used as a reinforcing material of the band layer, the steel cord preferably consists of three or more steel filaments twisted together. In a cross-section of the steel cord perpendicular to its longitudinal direction, provided that the cross-section of the filaments is surrounded by a virtual circle having a diameter of φ (mm) and the filaments each have a diameter of ψ (mm), the diameter φ is preferably within the range of not less than three times and not more than six times the diameter ψ. The steel filaments in the steel cord are spaced apart, so that buckling and breaking of the steel cord can be suppressed while obtaining the restriction force of the steel cord. Thus, improvement of durability may be facilitated.

The tire may include, at a position on an inner side of the band layer and on an outer side of the carcass layer in the tire radial direction, multiple belt layers each including belt cords which are inclined at an angle of 10 degrees or more and 45 degrees or less relative to the tire circumferential direction.

In this embodiment, as shown in FIG. 1 and FIG. 2, an outer edge 6be of the folded portion 6b of the folded carcass ply 6A ends at a position inwardly of the tread portion 2 and on the inner side of the band layer (belt layer) 7.

The folded carcass ply 6A does not necessarily end on the inner side of the band layer (belt layer) 7 as shown in FIG. 1 and FIG. 2.

This folded carcass ply 6A can increase the restriction force of the folded portion 6b and the band layer (belt layer) 7 at the tread edge 2t side mainly contacting the ground during turning due to the crossing of the carcass cords 11 of the folded portion 6b and the belt cords 12. Thus, the folded carcass ply 6A can enhance the lateral strength during turning and can improve turning performance.

In the tire 1 including the tread rubber 2A, a rubber composition containing the below-described components may be used as a tread rubber composition forming the tread rubber 2A, for example. When the tread rubber 2A is a multi-layer tread rubber, the rubber composition is appropriately usable in any of rubber layers in the multi-layer structure. Preferably, the rubber composition is suitably usable in a cap rubber layer that defines a surface of the tread rubber located on the outermost side in the tire radial direction.

The tread rubber composition contains a rubber component.

The rubber component contributes to crosslinking and generally correspond to a polymer component which has a weight average molecular weight (Mw) of 10000 or more and which are not extractable with acetone. The rubber component is solid at room temperature (25° C.).

The weight average molecular weight of the rubber component is preferably 50000 or more, more preferably 150000 or more, still more preferably 200000 or more, while it is preferably 2000000 or less, more preferably 1500000 or less, still more preferably 1000000 or less. When the weight average molecular weight is within the range indicated above, the advantageous effect tends to be better achieved.

Herein, the weight average molecular weight (Mw) can be determined by gel permeation chromatography (GPC) (GPC-8000 series available from Tosoh Corporation, detector: differential refractometer, column: TSKgel SuperMultipore HZ-M available from Tosoh Corporation) and calibrated with polystyrene standards.

Examples of rubber components which may be used in the tread rubber composition include diene-based rubbers. Examples of diene-based rubbers include isoprene-based rubbers, polybutadiene rubber (BR), styrene-butadiene rubber (SBR), styrene-isoprene-butadiene rubber (SIBR), ethylene-propylene-diene rubber (EPDM), chloroprene rubber (CR), and acrylonitrile-butadiene rubber (NBR). Examples also include butyl-based rubbers and fluororubbers. These may be used alone or in combinations of two or more. In order to better achieve the advantageous effect, isoprene-based rubbers, BR, and SBR are preferred among these, with BR or SBR being more preferred. These rubber components may also be subjected to the below-described modification or hydrogenation process. Rubbers extended with oils, resins, liquid rubber components, etc. are also usable.

The diene-based rubbers may be either unmodified or modified diene-based rubbers.

The modified diene-based rubbers may be any diene-based rubber having a functional group interactive with filler such as silica. Examples include a chain end-modified diene-based rubber obtained by modifying at least one chain end of a diene-based rubber with a compound (modifier) having the above functional group (i.e., a chain end-modified diene-based rubber terminated with the functional group); a backbone-modified diene-based rubber having the functional group in the backbone; a backbone- and chain end-modified diene-based rubber having the functional group in both the backbone and a chain end (e.g., a backbone- and chain end-modified diene-based rubber in which the backbone has the functional group and at least one chain end is modified with the modifier); and a chain end-modified diene-based rubber into which a hydroxy or epoxy group has been introduced by modification (coupling) with a polyfunctional compound having two or more epoxy groups in the molecule.

Examples of the functional group include amino, amide, silyl, alkoxysilyl, isocyanate, imino, imidazole, urea, ether, carbonyl, oxycarbonyl, mercapto, sulfide, disulfide, sulfonyl, sulfinyl, thiocarbonyl, ammonium, imide, hydrazo, azo, diazo, carboxy, nitrile, pyridyl, alkoxy, hydroxy, oxy, and epoxy groups. These functional groups may be substituted. Preferred among these are amino groups (preferably amino groups whose hydrogen atom is replaced with a C1-C6 alkyl group), alkoxy groups (preferably C1-C6 alkoxy groups), and alkoxysilyl groups (preferably C1-C6 alkoxysilyl groups).

Examples of isoprene-based rubbers include natural rubbers (NR), polyisoprene rubbers (IR), refined NR, modified NR, and modified IR. Examples of NR include those commonly used in the rubber industry such as SIR20, RSS #3, and TSR20. Any IR may be used, including those commonly used in the rubber industry such as IR2200. Examples of refined NR include deproteinized natural rubbers (DPNR) and highly purified natural rubbers (UPNR). Examples of modified NR include epoxidized natural rubbers (ENR), hydrogenated natural rubbers (HNR), and grafted natural rubbers. Examples of modified IR include epoxidized polyisoprene rubbers, hydrogenated polyisoprene rubbers, and grafted polyisoprene rubbers. These may be used alone or in combinations of two or more.

The amount of isoprene-based rubbers, if present, based on 100% by mass of the rubber component in the tread rubber composition is preferably 5% by mass or more, more preferably 50% by mass or more, still more preferably 60% by mass or more, while it is preferably 90% by mass or less, more preferably 80% by mass or less. When the amount is within the range indicated above, the advantageous effect tends to be better achieved.

Any BR may be used. Examples include high-cis BR having a high cis content, BR containing syndiotactic polybutadiene crystals, and BR synthesized using rare earth catalysts (rare earth-catalyzed BR). These may be used alone or in combinations of two or more. In particular, the BR preferably includes high-cis BR having a cis content of 90% by mass or higher. The cis content is more preferably 95% by mass or higher. Here, the cis content can be measured by infrared absorption spectrometry.

The BR may be either unmodified or modified BR. Examples of the modified BR include those into which functional groups as listed for the modified diene rubbers have been introduced. The BR may also be hydrogenated polybutadiene polymers (hydrogenated BR).

For example, usable commercial BR products are available from UBE Corporation, JSR Corporation, Asahi Kasei Corporation, Zeon Corporation, etc.

The amount of BR, if present, based on 100% by mass of the rubber component in the tread rubber composition is preferably 5% by mass or more, more preferably 15% by mass or more, still more preferably 20% by mass or more, particularly preferably 30% by mass or more. The upper limit is preferably 60% by mass or less, more preferably 50% by mass or less, still more preferably 40% by mass or less. When the amount is within the range indicated above, the advantageous effect tends to be better achieved.

Any SBR may be used. Examples include emulsion-polymerized styrene-butadiene rubbers (E-SBR) and solution-polymerized styrene-butadiene rubbers (S-SBR). These may be used alone or in combinations of two or more.

The styrene content of the SBR is preferably 5% by mass or higher, more preferably 8% by mass or higher, still more preferably 10% by mass or higher. The styrene content is preferably 50% by mass or lower, more preferably 35% by mass or lower, still more preferably 33% by mass or lower, further preferably 25% by mass or lower. When the styrene content is within the range indicated above, the advantageous effect tends to be improved.

Herein, the styrene content can be measured by ¹H-NMR analysis.

The vinyl bond content of the SBR is preferably 3% by mass or higher, more preferably 5% by mass or higher, still more preferably 7% by mass or higher. The vinyl bond content is preferably 35% by mass or lower, more preferably 30% by mass or lower, still more preferably 25% by mass or lower. When the vinyl bond content is within the range indicated above, the advantageous effect tends to be improved.

Herein, the vinyl bond content (1,2-butadiene unit content) can be measured by infrared absorption spectrometry.

The SBR may be either unmodified or modified SBR. Examples of the modified SBR include those into which functional groups as listed for the modified diene rubbers have been introduced. The SBR may also be hydrogenated styrene-butadiene copolymers (hydrogenated SBR).

SBR products manufactured or sold by Sumitomo Chemical Co., Ltd., JSR Corporation, Asahi Kasei Corporation, Zeon Corporation, etc. may be used as the SBR.

The amount of SBR, if present, based on 100% by mass of the rubber component in the tread rubber composition is preferably 50% by mass or more, more preferably 70% by mass or more, still more preferably 80% by mass or more, and may be 100% by mass or more. When the amount is within the range indicated above, the advantageous effect tends to be better achieved.

The tread rubber composition may contain a filler.

Any filler may be used, including materials known in the rubber field. Examples include inorganic fillers such as carbon black, silica, calcium carbonate, talc, alumina, clay, aluminum hydroxide, aluminum oxide, and mica; bio char; and hard-to-disperse fillers.

The total amount of fillers (the total amount of fillers such as silica and carbon black) per 100 parts by mass of the rubber component in the tread rubber composition is preferably 30 parts by mass or more, more preferably 60 parts by mass or more, still more preferably 65 parts by mass or more, particularly preferably 90 parts by mass or more. The upper limit of the total amount is preferably 150 parts by mass or less, more preferably 130 parts by mass or less, still more preferably 120 parts by mass or less, particularly preferably 100 parts by mass or less. When the total amount is within the range indicated above, the advantageous effect tends to be better achieved.

Carbon-derived fillers (carbon-containing fillers), such as carbon black, and silica are preferred among the fillers.

Non-limiting examples of carbon black usable in the tread rubber composition include N134, N110, N220, N234, N219, N339, N330, N326, N351, N550, and N762. Usable commercial products are available from Asahi Carbon Co., Ltd., Cabot Japan K.K., Tokai Carbon Co., Ltd., Mitsubishi Chemical Corporation, Lion Corporation, NIPPON STEEL Carbon Co., Ltd., Columbia Carbon, etc. These may be used alone or in combinations of two or more. In addition to the conventional carbon black made from mineral oils, etc., carbon black made from biomass materials such as lignin is also usable. The carbon black may be replaced with the same amount of recycled carbon black which is obtained by decomposing carbon black-containing products such as rubber products (i.e., tires) and plastic products.

The nitrogen adsorption specific surface area (N₂SA) of the carbon black in the tread rubber composition is preferably 50 m²/g or more, more preferably 70 m²/g or more, still more preferably 90 m²/g or more. The N₂SA is preferably 200 m²/g or less, more preferably 150 m²/g or less, still more preferably 145 m²/g or less, further preferably 120 m²/g or less. When the N₂SA is within the range indicated above, the advantageous effect tends to be better achieved.

Herein, the nitrogen adsorption specific surface area of the carbon black may be measured in accordance with JIS K 6217-2:2001.

The amount of carbon black, if present, per 100 parts by mass of the rubber component in the tread rubber composition is preferably 30 parts by mass or more, more preferably 60 parts by mass or more, still more preferably 65 parts by mass or more, particularly preferably 90 parts by mass or more. The upper limit of the amount is preferably 150 parts by mass or less, more preferably 130 parts by mass or less, still more preferably 120 parts by mass or less, particularly preferably 100 parts by mass or less. When the amount is within the range indicated above, the advantageous effect tends to be better achieved.

Examples of silica usable in the tread rubber composition include dry silica (anhydrous silica) and wet silica (hydrous silica). Wet silica is preferred among these because it contains a large number of silanol groups. Usable commercial products are available from Degussa, Rhodia, Tosoh Silica Corporation, Solvay Japan, Tokuyama Corporation, etc. These may be used alone or in combinations of two or more. In addition to the above-described types of silica, silica made from biomass materials such as rice husks is also usable.

The nitrogen adsorption specific surface area (N₂SA) of the silica is preferably 50 m²/g or more, more preferably 100 m²/g or more, still more preferably 150 m²/g or more, particularly preferably 180 m²/g or more, most preferably 190 m²/g or more. The upper limit of the N₂SA of the silica is not limited, and it is preferably 350 m²/g or less, more preferably 300 m²/g or less, still more preferably 250 m²/g or less. When the N₂SA is within the range indicated above, the advantageous effect tends to be better achieved.

Here, the N₂SA of the silica is measured by a BET method in accordance with ASTM D3037-93.

The amount of silica, if present, per 100 parts by mass of the rubber component in the tread rubber composition is preferably 5 parts by mass or more, more preferably 10 parts by mass or more. The upper limit of the amount is preferably 100 parts by mass or less, more preferably 50 parts by mass or less, still more preferably 30 parts by mass or less. When the amount is within the range indicated above, the advantageous effect tends to be better achieved.

When the tread rubber composition contains silica, it preferably further contains a silane coupling agent.

Any silane coupling agent may be used, and those known in the rubber field are usable. Examples include sulfide silane coupling agents such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 2-triethoxysilylethyl-N,N-dimethylthiocarbamoyltetrasulfide, and 3-triethoxysilylpropyl methacrylate monosulfide; mercapto silane coupling agents such as 3-mercaptopropyltrimethoxysilane, 2-mercaptoethyltriethoxysilane, and NXT and NXT-Z both available from Momentive; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products are available from Degussa, Momentive, Shin-Etsu Silicone, Tokyo Chemical Industry Co., Ltd., AZmax. Co., Dow Corning Toray Co., Ltd., etc. These may be used alone or in combinations of two or more.

The amount of silane coupling agents per 100 parts by mass of the silica content in the tread rubber composition is preferably 0.1 parts by mass or more, more preferably 3 parts by mass or more, still more preferably 5 parts by mass or more, particularly preferably 7 parts by mass or more. The upper limit of the amount is preferably 50 parts by mass or less, more preferably 20 parts by mass or less, still more preferably 15 parts by mass or less, particularly preferably 10 parts by mass or less. When the amount is within the range indicated above, the advantageous effect tends to be better achieved.

Examples of hard-to-disperse fillers include microfibrillated plant fibers, short fibrous celluloses, and gel compounds. Microfibrillated plant fibers are preferred among these.

In order to obtain good reinforcement, cellulose microfibrils are preferred among the microfibrillated plant fibers. Any cellulose microfibril derived from natural products may be used. Examples include those derived from resource biomass such as fruits, grains, and root vegetables; wood, bamboo, hemp, jute, and kenaf, and pulp, paper, or cloth produced therefrom; waste biomass such as agricultural waste, food waste, and sewage sludge; unused biomass such as rice straw, wheat straw, and thinnings; and celluloses produced by ascidians, acetic acid bacteria, or other organisms. These microfibrillated plant fibers may be used alone or in combinations of two or more.

Herein, the term “cellulose microfibrils” typically refers to cellulose fibers having an average fiber diameter of not more than 10 μm, more typically cellulose fibers having a microstructure with an average fiber diameter of not more than 500 nm formed by aggregation of cellulose molecules. For example, typical cellulose microfibrils may be formed as aggregates of cellulose fibers having an average fiber diameter as indicated above.

The amount of hard-to-disperse fillers per 100 parts by mass of the rubber component in the tread rubber composition is preferably 1 part by mass or more, more preferably 3 parts by mass or more, still more preferably 5 parts by mass or more. The upper limit of the amount is preferably 50 parts by mass or less, more preferably 30 parts by mass or less, still more preferably 20 parts by mass or less, particularly preferably 10 parts by mass or less. When the amount is within the range indicated above, the advantageous effect tends to be better achieved.

The tread rubber composition may contain a plasticizer.

The term “plasticizer” refers to a material that can impart plasticity to rubber components and may be liquid or solid at room temperature (25° C.).

The amount of plasticizers (the total amount of plasticizers) per 100 parts by mass of the rubber component in the tread rubber composition is preferably 5 parts by mass or more, more preferably 15 parts by mass or more, still more preferably 20 parts by mass or more, particularly preferably 25 parts by mass or more, while it is preferably 60 parts by mass or less, more preferably 52 parts by mass or less, still more preferably 50 parts by mass or less, further preferably 40 parts by mass or less, further preferably 30 parts by mass or less. When the amount is within the range indicated above, the advantageous effect tends to be better achieved. When the above-described extended rubbers are used, the amount of the extender components used in the extended rubbers is included in the amount of plasticizers.

Any plasticizer may be used in the tread rubber composition. Examples include oils, liquid polymers (liquid diene polymers, etc.), and resins. These may be used alone or in combinations of two or more.

Examples of oils include process oils, plant oils, and mixtures thereof. Examples of process oils include paraffinic process oils, aromatic process oils, and naphthenic process oils, such as mild extract solvates (MES), distillate aromatic extracts (DAE), treated distillate aromatic extracts (TDAE), treated residual aromatic extracts (TRAE), and residual aromatic extracts (RAE). Examples of plant oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. Usable commercial products are available from Idemitsu Kosan Co., Ltd., Sankyo Yuka Kogyo K.K., ENEOS Corporation, Olisoy, H&R, Hokoku Corporation, Showa Shell Sekiyu K.K., Fuji Kosan Co., Ltd., The Nisshin Oillio Group, Ltd., etc. Process oils, such as paraffinic process oils, aromatic process oils, and naphthenic process oils, and plant oils are preferred among these. In view of life cycle assessment, oils obtained by purifying lubricating oils used in rubber mixing machines, engines, or other applications, or waste cooking oils used in cooking establishments may also be used as the oils.

Examples of liquid diene polymers include liquid styrene-butadiene copolymers (liquid SBR), liquid polybutadiene polymers (liquid BR), liquid polyisoprene polymers (liquid IR), liquid styrene-isoprene copolymers (liquid SIR), liquid styrene-butadiene-styrene block copolymers (liquid SBS block polymers), liquid styrene-isoprene-styrene block copolymers (liquid SIS block polymers), liquid farnesene polymers, and liquid farnesene-butadiene copolymers, all of which are liquid at 25° C. These polymers may be modified at the chain end or backbone with a polar group. Hydrogenated products of these polymers are also usable.

Examples of the resins usable in the tread rubber composition include aromatic vinyl polymers, coumarone-indene resins, coumarone resins, indene resins, phenol resins, rosin resins, petroleum resins, terpene resins, and acrylic resins. These resins may be hydrogenated. These may be used alone or in combinations of two or more. Aromatic vinyl polymers, petroleum resins, and terpene resins are preferred among these. These resins may be solid or liquid at room temperature.

The amount of the above-described resins, if present, per 100 parts by mass of the rubber component in the tread rubber composition is preferably 5 parts by mass or more, more preferably 8 parts by mass or more, still more preferably 10 parts by mass or more, while it is preferably 30 parts by mass or less, more preferably 20 parts by mass or less, still more preferably 15 parts by mass or less. When the amount is within the range indicated above, the advantageous effect tends to be better achieved.

The softening point of the above-described resins is preferably 60° C. or higher, more preferably 70° C. or higher, still more preferably 80° C. or higher, further preferably 85° C. or higher. The upper limit is preferably 160° C. or lower, more preferably 130° C. or lower, still more preferably 115° C. or lower. When the softening point is within the range indicated above, the advantageous effect tends to be improved.

Here, the softening point of the above-described resins is determined in accordance with JIS K 6220-1:2001 using a ring and ball softening point measuring apparatus, and the temperature at which the ball drops down is defined as the softening point. The softening point of the resins indicated above is usually higher by 50° C.±5° C. than the glass transition temperature of the resins.

When the resins are liquid at room temperature, they have a softening point of preferably 30° C. or lower, more preferably 20° C. or lower, still more preferably 10° C. or lower.

The aromatic vinyl polymers refer to polymers containing aromatic vinyl monomers as structural units. Examples include resins produced by polymerization of α-methylstyrene and/or styrene. Specific examples include styrene homopolymers (styrene resins), α-methylstyrene homopolymers (α-methylstyrene resins), copolymers of α-methylstyrene and styrene, and copolymers of styrene and other monomers.

The coumarone-indene resins refer to resins containing coumarone and indene as the main monomer components forming the skeleton (backbone) of the resins. Examples of monomer components which may be contained in the skeleton in addition to coumarone and indene include styrene, α-methylstyrene, methylindene, and vinyltoluene.

The coumarone resins refer to resins containing coumarone as the main monomer component forming the skeleton (backbone) of the resins.

The indene resins refer to resins containing indene as the main monomer component forming the skeleton (backbone) of the resins.

Examples of the phenol resins include known polymers produced by reacting phenol with an aldehyde such as formaldehyde, acetaldehyde, or furfural in the presence of an acid or alkali catalyst. Preferred among these are those produced by reacting them in the presence of an acid catalyst, such as novolac phenol resins.

Examples of the rosin resins include rosin resins typified by natural rosins, polymerized rosins, modified rosins, and esterified compounds thereof, and hydrogenated products thereof.

Examples of the petroleum resins include C5 resins, C9 resins, C5/C9 resins, dicyclopentadiene (DCPD) resins, and hydrogenated products of these resins. DCPD resins and hydrogenated DCPD resins are preferred among these.

The terpene resins refer to polymers containing terpenes as structural units. Examples include polyterpene resins produced by polymerization of terpene compounds, and aromatic modified terpene resins produced by polymerization of terpene compounds and aromatic compounds. Hydrogenated products of these resins are also usable.

The polyterpene resins refer to resins produced by polymerization of terpene compounds. The terpene compounds refer to hydrocarbons having a composition represented by (C₅H₈)ₙ or oxygen-containing derivatives thereof, each of which has a terpene backbone and is classified as a monoterpene (C₁₀H₁₆), sesquiterpene (C₁₅H₂₄), diterpene (C₂₀H₃₂), or the like. Examples of the terpene compounds include α-pinene, β-pinene, dipentene, limonene, myrcene, alloocimene, ocimene, α-phellandrene, α-terpinene, γ-terpinene, terpinolene, 1,8-cineole, 1,4-cineole, α-terpineol, β-terpineol, and γ-terpineol.

Examples of the polyterpene resins include resins made from the above-described terpene compounds, such as pinene resins, limonene resins, dipentene resins, and pinene-limonene resins. Pinene resins are preferred among these. Pinene resins, which usually contain two isomers, α-pinene and β-pinene, are classified into β-pinene resins mainly containing β-pinene and α-pinene resins mainly containing α-pinene, depending on the proportions of the components in the resins.

Examples of the aromatic modified terpene resins include terpene-phenol resins made from the above-described terpene compounds and phenolic compounds, and terpene-styrene resins made from the above-described terpene compounds and styrene compounds. Terpene-phenol-styrene resins made from the terpene compounds, phenolic compounds, and styrene compounds are also usable. Here, examples of the phenolic compounds include phenol, bisphenol A, cresol, and xylenol, and examples of the styrene compounds include styrene and α-methylstyrene.

The acrylic resins refer to polymers containing acrylic monomers as structural units. Examples include styrene acrylic resins such as those which contain carboxy groups and are produced by copolymerization of aromatic vinyl monomer components and acrylic monomer components. Solvent-free, carboxy group-containing styrene acrylic resins are suitable among these.

The solvent-free, carboxy group-containing styrene acrylic resins may be (meth)acrylic resins (polymers) synthesized by high temperature continuous polymerization (high temperature continuous bulk polymerization as described in, for example, U.S. Pat. No. 4,414,370, JP S59-6207 A, JP H5-58005 B, JP H1-313522 A, U.S. Pat. No. 5,010,166, and annual research report TREND 2000 issued by Toagosei Co., Ltd., vol. 3, pp. 42-45, all of which are hereby incorporated by reference in their entirety) using no or minimal amounts of auxiliary raw materials such as polymerization initiators, chain transfer agents, and organic solvents. Herein, the term “(meth)acrylic” means methacrylic and acrylic.

Examples of the acrylic monomer components of the acrylic resins include (meth)acrylic acid and (meth)acrylic acid derivatives such as (meth)acrylic acid esters (e.g., alkyl esters, aryl esters, and aralkyl esters, such as 2-ethylhexyl acrylate), (meth)acrylamide, and (meth)acrylamide derivatives. Here, the term “(meth)acrylic acid” is a general term for acrylic acid and methacrylic acid.

Examples of the aromatic vinyl monomer components of the acrylic resins include aromatic vinyls such as styrene, α-methylstyrene, vinyltoluene, vinylnaphthalene, divinylbenzene, trivinylbenzene, and divinylnaphthalene.

In addition to the (meth)acrylic acid or (meth)acrylic acid derivatives and aromatic vinyls, other monomer components may also be used as the monomer components of the acrylic resins.

The plasticizers may be commercially available from, for example, Maruzen Petrochemical Co., Ltd., Sumitomo Bakelite Co., Ltd., Yasuhara Chemical Co., Ltd., Tosoh Corporation, Rutgers Chemicals, BASF, Arizona Chemical, Nitto Chemical Co., Ltd., Nippon Shokubai Co., Ltd., ENEOS Corporation, Arakawa Chemical Industries, Ltd., Taoka Chemical Co., Ltd., etc.

The tread rubber composition preferably contains an antioxidant in view of properties such as cracking resistance and ozone resistance.

Non-limiting examples of antioxidants include naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis[methylene-3-(3′,5′-di-t-butyl-4′-hydroxyphenyl)propionate]methane. Preferred among these are p-phenylenediamine antioxidants and quinoline antioxidants, with N-(1,3-dimethylbutyl)-N′-phenyl-p-phenylenediamine or polymerized 2,2,4-trimethyl-1,2-dihydroquinoline being more preferred. For example, usable commercial products are available from Seiko Chemical Co., Ltd., Sumitomo Chemical Co., Ltd., Ouchi Shinko Chemical Industrial Co., Ltd., Flexsys, etc.

The amount of antioxidants per 100 parts by mass of the rubber component in the tread rubber composition is preferably 0.5 parts by mass or more, more preferably 1.0 parts by mass or more, still more preferably 2.0 parts by mass or more. The amount is preferably 7.0 parts by mass or less, more preferably 4.0 parts by mass or less, still more preferably 3.0 parts by mass or less.

The tread rubber composition preferably contains stearic acid.

The amount of stearic acid per 100 parts by mass of the rubber component in the tread rubber composition is preferably 0.5 parts by mass or more, more preferably 1.0 parts by mass or more, still more preferably 2.0 parts by mass or more, further preferably 2.5 parts by mass or more. The amount is preferably 7.0 parts by mass or less, more preferably 4.0 parts by mass or less, still more preferably 3.0 parts by mass or less.

Here, conventionally known stearic acid may be used, including, for example, those available from NOF Corporation, Kao Corporation, FUJIFILM Wako Pure Chemical Corporation, Chiba Fatty Acid Co., Ltd., etc.

The tread rubber composition preferably contains zinc oxide.

The amount of zinc oxide per 100 parts by mass of the rubber component in the tread rubber composition is preferably 0.5 parts by mass or more, more preferably 1.0 parts by mass or more, still more preferably 2.0 parts by mass or more, further preferably 2.5 parts by mass or more. The amount is preferably 12.0 parts by mass or less, more preferably 11.0 parts by mass or less, still more preferably 10.0 parts by mass or less.

Here, conventionally known zinc oxide may be used, including, for example, those available from Mitsui Mining & Smelting Co., Ltd., Toho Zinc Co., Ltd., Hakusui Tech Co., Ltd., Seido Chemical Industry Co., Ltd., Sakai Chemical Industry Co., Ltd., etc.

The tread rubber composition may contain a wax.

The amount of waxes per 100 parts by mass of the rubber component in the tread rubber composition is preferably 0.5 parts by mass or more, more preferably 1.0 parts by mass or more, still more preferably 2.0 parts by mass or more. The amount is preferably 10.0 parts by mass or less, more preferably 7.0 parts by mass or less, still more preferably 5.0 parts by mass or less.

Any wax may be used. Examples include petroleum waxes, natural waxes, and synthetic waxes produced by purifying or chemically treating a plurality of waxes. These waxes may be used alone or in combinations of two or more.

Examples of petroleum waxes include paraffin waxes and microcrystalline waxes. Any natural wax derived from non-petroleum resources is usable. Examples include plant waxes such as candelilla wax, carnauba wax, Japan wax, rice wax, and jojoba wax; animal waxes such as beeswax, lanolin, and spermaceti; mineral waxes such as ozokerite, ceresin, and petrolatum; and purified products of these waxes. For example, usable commercial products are available from Ouchi Shinko Chemical Industrial Co., Ltd., Nippon Seiro Co., Ltd., Seiko Chemical Co., Ltd., etc.

The tread rubber composition preferably contains sulfur to moderately form crosslinks between the polymer chains, thereby imparting good properties.

The amount of sulfur per 100 parts by mass of the rubber component in the tread rubber composition is preferably 0.1 parts by mass or more, more preferably 1.0 parts by mass or more, still more preferably 1.5 parts by mass or more, further preferably 1.7 parts by mass or more. The amount is preferably 6.0 parts by mass or less, more preferably 5.0 parts by mass or less, still more preferably 4.0 parts by mass or less.

Examples of sulfur include those commonly used in the rubber industry, such as powdered sulfur, precipitated sulfur, colloidal sulfur, insoluble sulfur, highly dispersible sulfur, and soluble sulfur. Usable commercial products are available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. These may be used alone or in combinations of two or more.

The tread rubber composition preferably contains a vulcanization accelerator.

The amount of vulcanization accelerators in the tread rubber composition is not limited and may be freely determined according to the desired curing rate and crosslink density. The amount of vulcanization accelerators per 100 parts by mass of the rubber component is preferably 0.5 parts by mass or more, more preferably 1.0 parts by mass or more, still more preferably 1.5 parts by mass or more, further preferably 2.5 parts by mass or more. The upper limit is preferably 8.0 parts by mass or less, more preferably 6.0 parts by mass or less, still more preferably 4.0 parts by mass or less.

Any type of vulcanization accelerator may be used, including those generally used. Examples of vulcanization accelerators include benzothiazole vulcanization accelerators such as 2-mercaptobenzothiazole, di-2-benzothiazolyl disulfide, and N-cyclohexyl-2-benzothiazylsulfenamide; thiuram vulcanization accelerators such as tetramethylthiuram disulfide (TMTD), tetrabenzylthiuram disulfide (TBzTD), and tetrakis(2-ethylhexyl)thiuram disulfide (TOT-N); sulfenamide vulcanization accelerators such as N-cyclohexyl-2-benzothiazole sulfenamide, N-t-butyl-2-benzothiazolylsulfenamide, N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. These may be used alone or in combinations of two or more. Sulfenamide vulcanization accelerators, guanidine vulcanization accelerators, and benzothiazole vulcanization accelerators are preferred among these.

In addition to the above-described components, the tread rubber composition may appropriately contain agents commonly used in the tire industry, such as releasing agents or other materials.

The above-described materials in appropriately changed compounded amounts are usable for rubber compositions forming different tire components other than the tread rubber.

The tire can be produced by usual methods. For example, the tire is obtained by producing unvulcanized tire components such as a tread rubber by known methods, then assembling the tire components on a tire building machine by usual methods to form an unvulcanized tire, and heating and pressurizing the unvulcanized tire in a vulcanizer.

FIG. 3 shows a tire 1 according to another embodiment of the present disclosure.

In this embodiment, a folded carcass ply 6A includes an inner carcass ply 15 on an inner side in the tire radial direction on the tire equator C and an outer carcass ply 16 disposed outwardly of the inner carcass ply 15. The inner carcass ply 15 includes a main body 15a and a folded portion 15b, and the outer carcass ply 16 includes a main body 16a and a folded portion 16b.

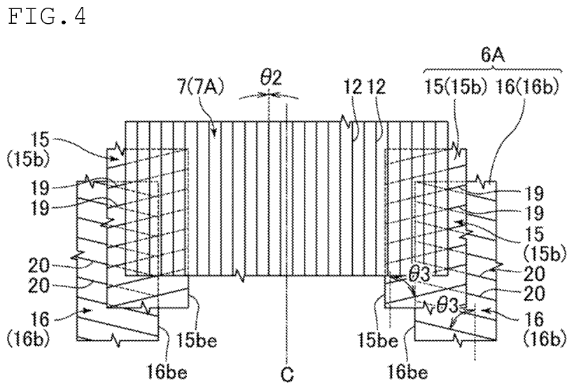

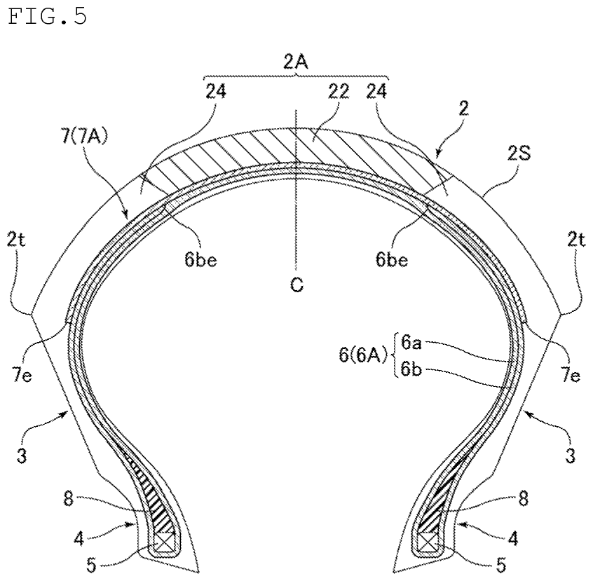

As shown in FIG. 4, carcass cords 19 in the inner carcass ply 15 and carcass cords 20 in the outer carcass ply 16 in this embodiment are inclined in opposite directions at a degree θ3 of for example 65 to 90 degrees relative to the tire equator C.

As shown in FIG. 3 and FIG. 4, an outer edge 15be of the folded portion 15b of the inner carcass ply 15 ends at a position inwardly of a tread portion 2 and on the inner side of a band layer (belt layer) 7 in the tire radial direction.

In this embodiment, like the inner carcass ply 15, an outer edge 16be of the folded portion 16b of the outer carcass ply 16 ends at a position on the inner side of the tread portion 2, the band layer (belt layer) 7, and the folded portion 15b of the inner carcass ply 15.

Such a folded portion 16b of the outer carcass ply 16 allows the carcass cords 20 therein to cross carcass cords 19 in the folded portion 15b of the inner carcass ply 15 and belt cords 12 at the tread edge 2t side, thereby potentially enhancing the restriction force of the folded portion 15b and the band layer (belt layer) 7.

The outer edge 16be of the outer carcass ply 16 and the outer edge 15be of the inner carcass ply 15 desirably end at different positions. The difference allows the inner carcass ply 15 and the outer carcass ply 16 to gradually increase the tread stiffness from the tire equator C side to the tread edge 2t side, thereby potentially improving transient characteristics during turning.

Further, the outer edge 16be of the outer carcass ply 16 desirably ends at a position closer to the outer side in the tire axial direction than the outer edge 15be of the inner carcass ply 15.

FIG. 5 shows a tire 1 according to another embodiment of the present disclosure.

In this embodiment, a tread rubber 2A includes multiple regions which are formed of different rubbers and located along the axial direction. In this embodiment, the multiple regions in the tread rubber 2A include a center region 22 and a pair of shoulder regions 24. This embodiment can more significantly achieve the advantageous effect.

Although the reason for the above-described effect derived from the tread rubber including a center region and a pair of shoulder regions is not exactly clear, the effect is believed to be due to the following mechanism. The posture of a car body during straight driving is different from the posture during turning, which changes the ground-contacting part of the tread portion in the tire as well as the load to the tread portion. Therefore, a tread rubber for straight running and a tread rubber for turning are selected and laid out, so that deformation can be optimized. Thus, improvement of durability may be facilitated.

The center region 22 is located at the center in the axial direction of the tire 1. An exemplary center region 22 is located at the center across the equator C in the axial direction. The center region 22 is useful to obtain braking performance upon entering a corner and acceleration performance during straight driving, for example. The shoulder regions 24 are useful to obtain grip force during turning and acceleration performance, for example.

The shoulder regions 24 are located on the axially outer side of the tire 1. Exemplary shoulder regions 24 are located on the outer sides of the center region 22 in the axial direction. In other words, the tread rubber 2A includes the shoulder regions 24 respectively on both sides of the center region 22 in the axial direction. The center region 22 and the shoulder regions 24 are desirably formed of cross-linked rubber having excellent abrasion resistance, excellent heat resistance, and excellent grip force. In the tire 1, the center region 22 desirably has a smaller complex modulus of elasticity E* than the shoulder regions 24.

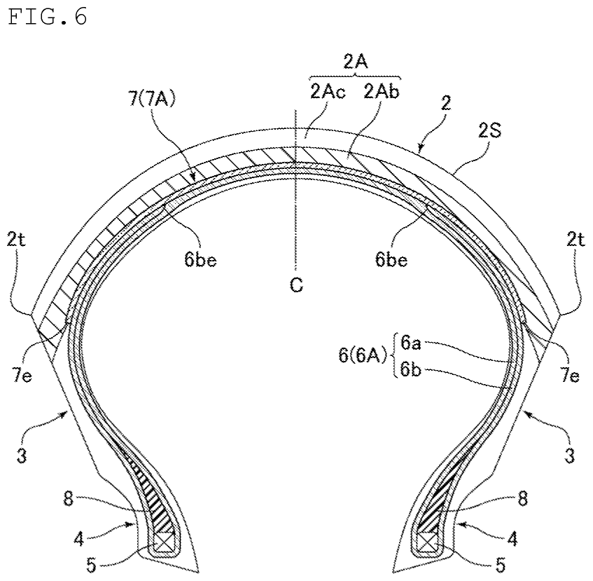

FIG. 6 shows a tire 1 according to another embodiment of the present disclosure.

In this embodiment, a tread rubber 2A includes multiple regions which are formed of different rubbers and located along the radial direction. In this embodiment, the tread rubber 2A is a two-layer tread rubber including a base rubber layer 2Ab that is located inwardly of a tread portion 2 and extends along a band layer (belt layer) 7 in the tire axial direction and a cap rubber layer 2Ac that is located on the radially outer side of the base rubber layer 2Ab and extends in the tire axial direction so as to define a tread face. This tread rubber 2A can more significantly achieve the advantageous effect.

Although the reason for the above-described effect derived from the tread rubber including a cap rubber layer and a base rubber layer is not exactly clear, the effect is believed to be due to the following mechanism.

The two or more-layer tread rubber has interfaces in the tread portion. The interfaces can absorb an input from the road surface and can suppress the force on the carcass cords. Thus, improvement of durability may be facilitated.

The present disclosure may be applied to a tire such as a pneumatic tire or a non-pneumatic tire, preferably a pneumatic tire. In particular, the tire may be suitably used as a summer tire or winter tire (e.g., studless tire, cold weather tire, snow tire, studded tire). The tire may be used as a tire for passenger cars, large passenger cars, large SUVs, heavy duty vehicles such as trucks and buses, light trucks, or motorcycles, or as a racing tire (high performance tire), etc. In particular, the tire may be suitably used as a motorcycle tire.

Although particularly preferred embodiments of the present disclosure are described in detail above, the present disclosure is not limited to the embodiments shown in the figures and may be implemented in various modified embodiments.

### Examples

Examples (working examples) which are considered preferable to implement the present disclosure are described below although the scope of the embodiment is not limited to the examples.

Carcass plies each having a basic structure shown in FIG. 1 (a monolayer tread rubber), FIG. 5 (a tread rubber including a center region and a pair of shoulder regions), or FIG. 6 (a two-layer tread rubber consisting of a cap rubber layer and a base rubber layer) and having a specification shown in Table 4 or 5 are prepared. Rear motorcycle tires each including any of the carcass plies are produced and are tested for their performance.

The common specifications are described below.

### Tire Size:

180/55ZR17

### Rim Size:

Rear wheel: MT5.50×17
   Tread width TW: 180 mm
   Developed half-width of tread 0.5 TWe: 90 mm

### Carcass:

Folded carcass ply:
   Angle θ1 of carcass cord: 90 degrees
   End count of carcass cord: 40/5 cm
Inner carcass ply and outer carcass ply:
   Angle θ3 of carcass cord: 80 degrees
   End count of carcass cord: 40/5 cm

### Band Layer:

Number of jointless ply: 1
Width W1 of jointless ply: 168 mm
Ratio W1/TW: 93%
Material of belt cord: steel
Angle θ2 of belt cord: 0 degrees
   Tread rubber compositions: shown in Tables 1 to 3

The test method is described below.

Reference comparative example is as follows.

Reference comparative example: Comparative Example 1

TABLE 1
Monolayer tread rubber

| | | Tread rubber |
|---|---|---|
| Compounded | SBR | 110 |
| amount | BR | 20 |
| (parts | Carbon black 1 | 90 |
| by | Oil | 10 |
| mass) | Resin | 10 |
| | Wax | 1 |
| | Antioxidant | 1 |
| | Stearic acid | 2.5 |
| | Zinc oxide | 2.5 |
| | Sulfur | 1.5 |
| | Vulcanization accelerator | 1.5 |

TABLE 2
Tread rubber including a center region
and a pair of shoulder regions

| | | Center | Shoulder |
|---|---|---|---|
| | | region | region |
| Compounded | SBR | 96.25 | 137.5 |
| amount | BR | 30 | — |
| (parts | Carbon black 1 | 90 | 100 |
| by | Oil | 20 | 5 |
| mass) | Resin | 5 | 15 |
| | Wax | 1 | 1 |
| | Antioxidant | 1 | 1 |
| | Stearic acid | 2.5 | 2.5 |
| | Zinc oxide | 2.5 | 2.5 |
| | Sulfur | 1.5 | 1.5 |
| | Vulcanization accelerator | 1.5 | 1.5 |

TABLE 3
Two-layer tread rubber consisting of cap
rubber layer and base rubber layer

| | | Cap rubber | Base rubber |
|---|---|---|---|
| | | layer | layer |
| Compounded | SBR | 110 | — |
| amount | BR | 20 | 40 |
| (parts | NR | — | 60 |
| by | Carbon black 1 | 90 | — |
| mass) | Carbon black 2 | — | 50 |
| | Oil | 10 | 10 |
| | Resin | 10 | — |
| | Wax | 1 | 1 |
| | Antioxidant | 1 | 1.5 |
| | Stearic acid | 2.5 | 2.5 |
| | Zinc oxide | 2.5 | 2.5 |
| | Sulfur | 1.5 | 2.5 |
| | Vulcanization accelerator | 1.5 | 2 |

The materials of the tread rubber are as follows.
SBR3830: TUFUDENE 3830 (styrene content: 33% by mass, oil content: 37.5 parts by mass per 100 parts by mass of solid rubber content) available from Asahi Kasei Corporation
BR: UBEPOL BR150B (high-cis BR synthesized with a Co catalyst) available from Ube Industries, Ltd.
NR: RSS #3
Carbon black 1: SHOBLACK N110 (N₂SA: 145 m²/g) available from Cabot Japan K.K.
Carbon black 2: SHOBLACK N326 (N₂SA: 81 m²/g) available from Cabot Japan K.K.
Oil: NH-70 available from Idemitsu Kosan Co., Ltd.
Resin: Sylvatraxx 4401 (a copolymer of α-methylstyrene and styrene, softening point: 85° C.) available from Arizona Chemical
Wax: Ozoace 0355 available from Nippon Seiro Co., Ltd.
Antioxidant: Antigen 6C (N-(1,3-dimethylbutyl)-N′-phenyl-p-phenylenediamine) available from Sumitomo Chemical Co., Ltd.
Stearic acid: stearic acid “TSUBAKI” available from NOF Corporation
Zinc oxide: Ginrei R available from Toho Zinc Co., Ltd.
Sulfur: HK-200-5 (powdered sulfur) available from Hosoi Chemical Industry Co., Ltd.
Vulcanization accelerator: NOCCELER NS-G (N-tert-butyl-2-benzothiazolylsulfenamide) available from Ouchi Shinko Chemical Industrial Co., Ltd.

### [Durability]

Each tire is run on a drum tester under the conditions of a 20×8.0JJ rim, an internal pressure of 230 kPa, and a running speed of 81 km/h. The applied load is increased by 15% in every four hours from 85% of the maximum load defined in JATMA. The running distance until the tire is broken is measured. In the case where the applied load reaches 280% of the maximum load defined in JATMA, the running is continued while applying 280% of the maximum load as a final load until failure occurs. The result is expressed as an index relative to the result in the reference comparative example taken as 100. A higher index indicates better durability.

TABLE 4

| | | Example 1 | Example 2 | Example 3 | Example 4 | Example 5 |
|---|---|---|---|---|---|---|
| Specification | Materials of hybrid cord | PET + Aramid | PET + Aramid | PET + Aramid | PET + Aramid | PET + Aramid |
| | Structure of hybrid cord | 1100 dtex/1 + | 1670 dtex/1 + | 1100 dtex/1 + | 1100 dtex/3 (PET/ | 1670 dtex/1 + |
| | | 1100 dtex/1 | 1670 dtex/1 | 1100 dtex/1 | 2, Aramid/1) | 1670 dtex/1 |
| | Final twist number R3 [times/ | 40.0 | 42.0 | 45.0 | 35.0 | 40.0 |
| | 10 cm] of hybrid cord | | | | | |
| | Twist coefficient K3 | 1876 | 2427 | 2111 | 2011 | 2312 |
| | Structure of tread rubber | Monolayer | Monolayer | Monolayer | Monolayer | Monolayer |
| | Thickness L [mm] of thread | 8.0 | 8.5 | 9.0 | 7.5 | 7.0 |
| | rubber | | | | | |
| | K3 × L | 15009 | 20632 | 18996 | 15079 | 16182 |
| | R1 | 40.0 | 47.0 | 47.0 | 40.0 | 45.0 |
| | R2 | 40.0 | 42.0 | 42.5 | 35.0 | 33.0 |
| | K1 | 1327 | 1921 | 1559 | 1327 | 1839 |
| | K2 | 1327 | 1716 | 1410 | 1161 | 1349 |
| | K1/K2 | 1.00 | 1.12 | 1.11 | 1.14 | 1.36 |
| | Total fineness D3 [dtex] of | 2200 | 3340 | 2200 | 3300 | 3340 |
| | hybrid cord | | | | | |
| | R3 × L | 320.0 | 357.0 | 405.0 | 262.5 | 280.0 |
| | (K1/K2) × L | 8.0 | 9.5 | 10.0 | 8.6 | 9.5 |
| Evaluation | Durability | 120 | 125 | 120 | 120 | 110 |

| | | Example 6 | Example 7 | Example 8 | Example 9 | Example 10 |
|---|---|---|---|---|---|---|
| Specification | Materials of hybrid cord | PET + Aramid | PET + Aramid | PET + Aramid | PET + Aramid | PET + Aramid |
| | Structure of hybrid cord | 1100 dtex/3 (PET/ | 700 dtex/1 + | 800 dtex/1 + | 1670 dtex/1 + | 1670 dtex/1 + |
| | | 1, Aramid/2) | 700 dtex/1 | 800 dtex/1 | 1100 dtex/1 | 1670 dtex/1 |
| | Final twist number R3 [times/ | 40.0 | 55.0 | 57.0 | 45.0 | 40.0 |
| | 10 cm] of hybrid cord | | | | | |
| | Twist coefficient K3 | 2298 | 2058 | 2280 | 2368 | 2312 |
| | Structure of tread rubber | Monolayer | Monolayer | Monolayer | Center region | Cap rubber |
| | | | | | and a pair of | layer and |
| | | | | | shoulder | Base rubber |
| | | | | | regions | layer |
| | Thickness L [mm] of thread | 9.5 | 9.0 | 7.5 | 9.0 | 8.0 |
| | rubber | | | | | |
| | K3 × L | 21829 | 18521 | 17100 | 21315 | 18494 |
| | R1 | 35.0 | 50.0 | 55.0 | 45.0 | 47.5 |
| | R2 | 40.0 | 55.0 | 60.0 | 45.0 | 40.0 |
| | K1 | 1161 | 1323 | 1556 | 1273 | 1344 |
| | K2 | 1327 | 1455 | 1697 | 1273 | 1131 |
| | K1/K2 | 0.88 | 0.91 | 0.92 | 1.00 | 1.19 |
| | Total fineness D3 [dtex] of | 3300 | 1400 | 1600 | 2770 | 3340 |
| | hybrid cord | | | | | |
| | R3 × L | 380.0 | 495.0 | 427.5 | 405.0 | 320.0 |
| | (K1/K2) × L | 8.3 | 8.2 | 6.9 | 9.0 | 9.5 |
| Evaluation | Durability | 105 | 105 | 105 | 130 | 125 |

TABLE 5

| | | Comparative | Comparative | Comparative | Comparative | Comparative |
|---|---|---|---|---|---|---|
| | | Example 1 | Example 2 | Example 3 | Example 4 | Example 5 |
| Specification | Materials of hybrid cord | PET | Aramid | PET + Aramid | PET + Aramid | Aramid |
| | Structure of hybrid cord | 1100 dtex/2 | 1670 dtex/2 | 2200 dtex/3 (PET/ | 1670 dtex/1 + | 1100 dtex/2 |
| | | | | 1, Aramid/2) | 1670 dtex/1 | |
| | Final twist number R3 times/ | 45.0 | 25.0 | 35.0 | 30.0 | 35.0 |
| | 10 cm] of hybrid cord | | | | | |
| | Twist coefficient K3 | 2111 | 1445 | 2843 | 1734 | 1642 |
| | Structure of tread rubber | Monolayer | Monolayer | Monolayer | Monolayer | Monolayer |
| | Thickness L [mm] of thread | 7.0 | 10.5 | 4.5 | 5.0 | 5.5 |
| | rubber | | | | | |
| | K3 × L | 14775 | 15171 | 12795 | 8669 | 9029 |
| | R1 | 45.0 | 25.0 | 28.0 | 25.0 | 35.0 |
| | R2 | 45.0 | 25.0 | 32.0 | 30.0 | 35.0 |
| | K1 | 1492 | 1022 | 929 | 1022 | 1161 |
| | K2 | 1492 | 3231 | 1061 | 1226 | 1161 |
| | K1/K2 | 1.00 | 0.32 | 0.88 | 0.83 | 1.00 |
| | Total fineness D3 [dtex] of | 2200 | 3340 | 6600 | 3340 | 2200 |
| | hybrid cord | | | | | |
| | R3 × L | 315.0 | 262.5 | 157.5 | 150.0 | 192.5 |
| | (K1/K2) × L | 7.0 | 3.3 | 3.9 | 4.2 | 5.5 |
| Evaluation | Durability | 100 | 80 | 75 | 85 | 90 |

| | | Comparative | Comparative | Comparative | Comparative |
|---|---|---|---|---|---|
| | | Example 6 | Example 7 | Example 8 | Example 9 |
| Specification | Materials of hybrid cord | PET | PET + Aramid | PET | Aramid |
| | Structure of hybrid cord | 1600 dtex/2 | 1100 dtex/1 + | 1100 dtex/2 | 1100 dtex/2 |
| | | | 1100 dtex/1 | | |
| | Final twist number R3 [times/ | 38.0 | 38.0 | 42.0 | 35.0 |
| | 10 cm] of hybrid cord | | | | |
| | Twist coefficient K3 | 1782 | 1782 | 1970 | 1642 |
| | Structure of tread rubber | Monolayer | Monolayer | Monolayer | Monolayer |
| | Thickness L [mm] of thread | 8.0 | 7.5 | 7.5 | 9.6 |
| | rubber | | | | |
| | K3 × L | 14259 | 13368 | 14775 | 15760 |
| | R1 | — | 45.0 | — | — |
| | R2 | — | 38.0 | — | — |
| | K1 | — | 1492 | — | — |
| | K2 | — | 1260 | — | — |
| | K1/K2 | — | 1.18 | — | — |
| | Total fineness D3 [dtex] of | 2200 | 2200 | 2200 | 2200 |
| | hybrid cord | | | | |
| | R3 × L | 304.0 | 285.0 | 315.0 | 336.0 |
| | (K1/K2) × L | — | 8.9 | — | — |
| Evaluation | Durability | 85 | 95 | 90 | 85 |

Exemplary embodiments of the present disclosure include:

Embodiment 1. A tire, including:
a tread rubber; and
a carcass containing a hybrid cord of at least one polyamide fiber yarn and at least one polyester fiber yarn,
the hybrid cord having a twist coefficient K3 of 1800 or more and 2600 or less in final twisting as determined by R3×(D3)^{1/2} where R3 is a final twist number [times/10 cm] of the hybrid cord and D3 is a total fineness [dtex] of the hybrid cord,
the twist coefficient K3 and a thickness L [mm] of the tread rubber giving a product (K3×L) of 15000 or more.

Embodiment 2. The tire according to Embodiment 1,
wherein, provided that: the polyester fiber yarn has a twist coefficient K2 in first twisting as determined by R2×(D2)^{1/2} where R2 is a first twist number [times/10 cm] of the polyester fiber yarn and D2 is a total fineness [dtex] of the polyester fiber yarn; and the polyamide fiber yarn has a twist coefficient K1 in first twisting as determined by R1×(D1)^{1/2} where R1 is a first twist number [times/10 cm] of the polyamide fiber yarn and D1 is a total fineness [dtex] of the polyamide fiber yarn, a ratio (K1/K2) of the twist coefficient K1 to the twist coefficient K2 is 1.00 or higher and 1.30 or lower.

Embodiment 3. The tire according to Embodiment 1 or 2,
wherein the hybrid cord is a hybrid cord of twisted two yarns consisting of one polyamide fiber yarn and one polyester fiber yarn or a hybrid cord of twisted three yarns consisting of one polyamide fiber yarn and two polyester fiber yarns.

Embodiment 4. The tire according to any combination with any one of Embodiments 1 to 3,
wherein the total fineness D3 of the hybrid cord is 1600 to 5500 dtex.

Embodiment 5. The tire according to any combination with any one of Embodiments 1 to 4,
wherein the final twist number R3 of the hybrid cord is 30.0 to 55.0 times/10 cm.

Embodiment 6. The tire according to any combination with any one of Embodiments 1 to 5,
wherein the thickness L of the tread rubber is 6.0 mm or more.

Embodiment 7. The tire according to any combination with any one of Embodiments 1 to 6,
wherein the twist coefficient K3 is 2200 or more and 2500 or less.

Embodiment 8. The tire according to any combination with any one of Embodiments 1 to 7,
wherein the product of K3×L is 19000 or more.

Embodiment 9. The tire according to any combination with any one of Embodiments 1 to 8,
wherein a product (R3×L) of the final twist number R3 [times/10 cm] of the hybrid cord and the thickness L [mm] of the tread rubber is 340.0 or more and 405.0 or less.

Embodiment 10. The tire according to any combination with any one of Embodiments 1 to 9,
wherein a product ((K1/K2)×L) of the ratio K1/K2 and the thickness L [mm] of the tread rubber is 8.6 or more and 9.7 or less.

Embodiment 11. The tire according to any combination with any one of Embodiments 1 to 10,
wherein the first twist number R1 of the polyamide fiber yarn is 40.0 to 50.0 times/10 cm.

Embodiment 12. The tire according to any combination with any one of Embodiments 1 to 11,
wherein the first twist number R2 of the polyester fiber yarn is 35.0 to 55.0 times/10 cm.

Embodiment 13. The tire according to any combination with any one of Embodiments 1 to 12,
wherein the twist coefficient K1 of the polyamide fiber yarn in first twisting is 1200 or more and 2300 or less as determined by R1×(D1)^{1/2} where R1 is the first twist number [times/10 cm] of the polyamide fiber yarn and D1 is the total fineness [dtex] of the polyamide fiber yarn.

Embodiment 14. The tire according to any combination with any one of Embodiments 1 to 13,
wherein the twist coefficient K2 of the polyester fiber yarn in first twisting is 1100 or more and 2000 or less as determined by R2×(D2)^{1/2} where R2 is the first twist number [times/10 cm] of the polyester fiber yarn and D2 is the total fineness [dtex] of the polyester fiber yarn.

Embodiment 15. The tire according to any combination with any one of Embodiments 1 to 14, wherein the polyamide forming the polyamide fiber is at least one of a semi-aromatic polyamide or a fully aromatic polyamide.

Embodiment 16. The tire according to any combination with any one of Embodiments 1 to 15, wherein the polyester forming the polyester fiber is polyethylene terephthalate.

Embodiment 17. The tire according to any combination with any one of Embodiments 1 to 16, wherein the tread rubber includes a tread rubber composition that contains a rubber component including styrene-butadiene rubber and polybutadiene rubber.

Embodiment 18. The tire according to any combination with any one of Embodiments 1 to 17, wherein the tread rubber includes a center region and a pair of shoulder regions.

Embodiment 19. The tire according to any combination with any one of Embodiments 1 to 18, wherein the tread rubber includes a cap rubber layer and a base rubber layer.

Embodiment 20. The tire according to any combination with any one of Embodiments 1 to 19, which is a motorcycle tire.

### REFERENCE SIGNS LIST

1 motorcycle tire
2 tread portion
2A tread rubber
6 carcass
6A folded carcass ply
7 belt layer
7A jointless ply
11 carcass cord
12 belt cord

1. A tire, comprising:
a tread rubber; and
a carcass comprising a hybrid cord of at least one polyamide fiber yarn and at least one polyester fiber yarn,
the hybrid cord having a twist coefficient K3 of 1800 or more and 2600 or less in final twisting as determined by R3×(D3)^{1/2} where R3 is a final twist number [times/10 cm] of the hybrid cord and D3 is a total fineness [dtex] of the hybrid cord,
the twist coefficient K3 and a thickness L [mm] of the tread rubber giving a product (K3×L) of 15000 or more.

2. The tire according to claim 1,
wherein, provided that: the polyester fiber yarn has a twist coefficient K2 in first twisting as determined by R2×(D2)^{1/2} where R2 is a first twist number [times/10 cm] of the polyester fiber yarn and D2 is a total fineness [dtex] of the polyester fiber yarn; and the polyamide fiber yarn has a twist coefficient K1 in first twisting as determined by R1×(D1)^{1/2} where R1 is a first twist number [times/10 cm] of the polyamide fiber yarn and D1 is a total fineness [dtex] of the polyamide fiber yarn, a ratio (K1/K2) of the twist coefficient K1 to the twist coefficient K2 is 1.00 or higher and 1.30 or lower.

3. The tire according to claim 1,
wherein the hybrid cord is a hybrid cord of twisted two yarns consisting of one polyamide fiber yarn and one polyester fiber yarn or a hybrid cord of twisted three yarns consisting of one polyamide fiber yarn and two polyester fiber yarns.

4. The tire according to claim 1,
wherein the total fineness D3 of the hybrid cord is 1600 to 5500 dtex.

5. The tire according to claim 1,
wherein the final twist number R3 of the hybrid cord is 30.0 to 55.0 times/10 cm.

6. The tire according to claim 1,
wherein the thickness L of the tread rubber is 6.0 mm or more.

7. The tire according to claim 1,
wherein the twist coefficient K3 is 2200 or more and 2500 or less.

8. The tire according to claim 1,
wherein the product of K3×L is 19000 or more.

9. The tire according to claim 1,
wherein a product (R3×L) of the final twist number R3 [times/10 cm] of the hybrid cord and the thickness L [mm] of the tread rubber is 340.0 or more and 405.0 or less.

10. The tire according to claim 1,
wherein a product ((K1/K2)×L) of the ratio K1/K2 and the thickness L [mm] of the tread rubber is 8.6 or more and 9.7 or less.

11. The tire according to claim 1,
wherein the first twist number R1 of the polyamide fiber yarn is 40.0 to 50.0 times/10 cm.

12. The tire according to claim 1,
wherein the first twist number R2 of the polyester fiber yarn is 35.0 to 55.0 times/10 cm.

13. The tire according to claim 1,
wherein the twist coefficient K1 of the polyamide fiber yarn in first twisting is 1200 or more and 2300 or less as determined by R1×(D1)^{1/2} where R1 is the first twist number [times/10 cm] of the polyamide fiber yarn and D1 is the total fineness [dtex] of the polyamide fiber yarn.

14. The tire according to claim 1,
wherein the twist coefficient K2 of the polyester fiber yarn in first twisting is 1100 or more and 2000 or less as determined by R2×(D2)^{1/2} where R2 is the first twist number [times/10 cm] of the polyester fiber yarn and D2 is the total fineness [dtex] of the polyester fiber yarn.

15. The tire according to claim 1,
wherein the polyamide forming the polyamide fiber is at least one of a semi-aromatic polyamide or a fully aromatic polyamide.

16. The tire according to claim 1,
wherein the polyester forming the polyester fiber is polyethylene terephthalate.

17. The tire according to claim 1,
wherein the tread rubber comprises a tread rubber composition that contains a rubber component including styrene-butadiene rubber and polybutadiene rubber.

18. The tire according to claim 1,
wherein the tread rubber comprises a center region and a pair of shoulder regions.

19. The tire according to claim 1,
wherein the tread rubber comprises a cap rubber layer and a base rubber layer.

20. The tire according to claim 1, which is a motorcycle tire.
